(19) United States
(12) Patent Application Publication
(10) Pub. No.: US 2022/0092253 A1
(43) Pub. Date: Mar. 24, 2022

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventor: Kengo TOKUCHI, Kanagawa (JP)

(73) Assignee: FUJIFILM Business Innovation Corp., Tokyo (JP)

(21) Appl. No.: 17/145,410

(22) Filed: Jan. 11, 2021

(30) Foreign Application Priority Data
Sep. 18, 2020 (JP) 2020-157817

(51) Int. Cl. G06F 40/166; G06F 40/197; G06K 9/00

(52) U.S. Cl. CPC G06F 40/166; G06K 9/00483; G06F 40/197

(57) ABSTRACT

An information processing apparatus includes a processor configured to, when executing software that is capable of displaying electronic information including at least one of a document and an image so that the electronic information is displayed, display the electronic information in an aspect that matches at least one of a use state of the electronic information and environmental information indicating environment around a place where the electronic information is displayed.

### CROSS-REFERENCE TO RELATED APPLICATIONS

This application is based on and claims priority under 35 USC 119 from Japanese Patent Application No. 2020-157817 filed Sep. 18, 2020.

### BACKGROUND

### (i) Technical Field

The present disclosure relates to an information processing apparatus and a non-transitory computer readable medium.

### (ii) Related Art

In Japanese Unexamined Patent Application Publication No. 2000-155709, an electronic document browsing system that is capable of, in a case where editing was performed on a part of a shared electronic document after the last time a user browsed the shared electronic document, clearly indicating the edited part for another part of the shared electronic document, is described.

### SUMMARY

For example, electronic information such as an electronic document and an electronic book is able to be displayed by an electronic book reader or the like. In the case where electronic information is editable, displayed content may be different between before editing and after editing. In this case, there is a difference only in the displayed content because the electronic information itself has been changed. A change in an aspect of a bound book, such as bending or wetting of paper caused by a use state or the environment around a place where a user reads the book does not appear on display of the electronic information.

Aspects of non-limiting embodiments of the present disclosure relate to changing an aspect of display of electronic information.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to, when executing software that is capable of displaying electronic information including at least one of a document and an image so that the electronic information is displayed, display the electronic information in an aspect that matches at least one of a use state of the electronic information and environmental information indicating environment around a place where the electronic information is displayed.

### BRIEF DESCRIPTION OF THE DRAWINGS

Exemplary embodiments of the present disclosure will be described in detail based on the following figures, wherein:

FIG. 1 is a block diagram illustrating a hardware configuration of an information processing apparatus;

FIG. 2 is a flowchart illustrating a first flow of an electronic information display process;

FIG. 3 illustrates a display example of image information to which no additional information has been added;

FIG. 4 illustrates a first display example of image information to which additional information has been added;

FIG. 5 illustrates a second display example of image information to which additional information has been added;

FIG. 6 is a flowchart illustrating a second flow of the electronic information display process;

FIG. 7 illustrates a first display example of electronic material to which acquisition information has been added;

FIG. 8 illustrates a second display example of electronic material to which acquisition information has been added;

FIG. 9 illustrates a third display example of electronic material to which acquisition information has been added;

FIG. 10 illustrates a fourth display example of electronic material to which acquisition information has been added;

FIG. 11 is a flowchart illustrating a third flow of the electronic information display process;

FIG. 12 illustrates a first display example of an electronic book to which no acquisition information has been added;

FIG. 13 illustrates a first display example of an electronic book to which acquisition information has been added;

FIG. 14 illustrates a second display example of an electronic book to which no acquisition information has been added;

FIG. 15 illustrates a second display example of an electronic book to which acquisition information has been added;

FIG. 16 illustrates a third display example of an electronic book to which no acquisition information has been added;

FIG. 17 illustrates a third display example of an electronic book to which acquisition information has been added;

FIG. 18 is a flowchart illustrating a fourth flow of the electronic information display process;

FIG. 19 illustrates a display example of electronic material to which no acquisition information has been added;

FIG. 20 illustrates a fourth display example of electronic material to which acquisition information has been added;

FIG. 21 illustrates a first display example of a state in which an image is being captured by a photographing unit;

FIG. 22 illustrates a fifth display example of electronic material to which acquisition information has been added;

FIG. 23 is a flowchart illustrating a fifth flow of the electronic information display process;

FIG. 24 illustrates a display example of an electronic book to which advertising information has been added;

FIG. 25 illustrates a first display example of a list screen on which a list of electronic books is displayed;

FIG. 26 illustrates a second display example of the list screen on which the list of electronic books is displayed;

FIG. 27 is a flowchart illustrating a sixth flow of the electronic information display process;

FIG. 28 illustrates a display example of electronic material distributed from a data distribution server;

FIG. 29 illustrates a sixth display example of electronic material to which acquisition information has been added;

FIG. 30 illustrates a seventh display example of electronic material to which acquisition information has been added;

FIG. 31 illustrates an eighth display example of electronic material to which acquisition information has been added;

FIG. 32 illustrates a second display example of a state in which an image is being captured by the photographing unit;

FIG. 33 illustrates a third display example of a state in which an image is being captured by the photographing unit;

FIG. 34 illustrates a display example of an end position at which detection of contact on a display by a detection unit ends;

FIG. 35 illustrates a display example of a locus of the position of contact on the display detected by the detection unit;

FIG. 36 illustrates a fourth display example of an electronic book to which acquisition information has been added;

FIG. 37 illustrates a display example of a locus of the position of contact on the display detected by the detection unit; and

FIG. 38 illustrates a fifth display example of an electronic book to which acquisition information has been added.

### DETAILED DESCRIPTION

Hereinafter, an information processing apparatus 10 according to an exemplary embodiment will be described.

### First Exemplary Embodiment

The information processing apparatus 10 is, for example, a portable terminal such as a smart phone, a tablet terminal, or a portable notebook personal computer (PC) that is capable of executing software that is capable of displaying electronic information including at least one of a document and an image. Hereinafter, such software will be referred to as “specific software”. The specific software is, for example, document creation software, spreadsheet software, presentation software, image photographing software capable of capturing an image with a camera, viewer software capable of browsing data created by the document creation software or the like, data captured by the image photographing software, and the like, or an electronic book reader, which is software for browsing electronic books.

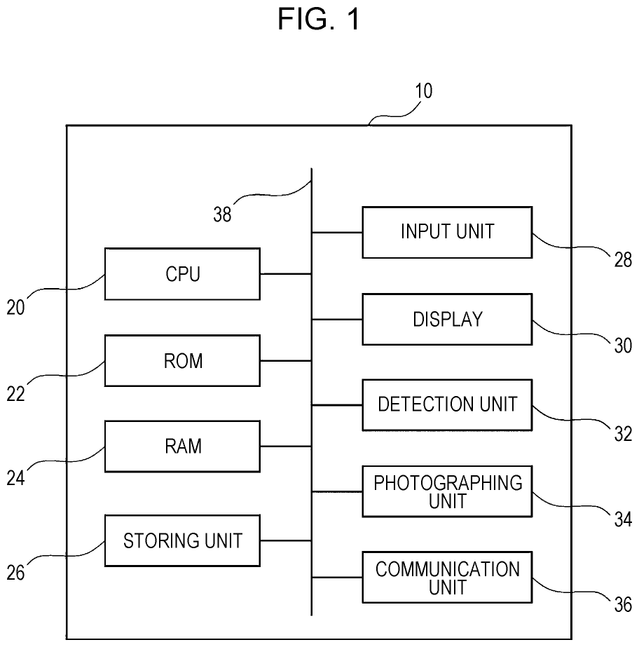

FIG. 1 is a block diagram illustrating a hardware configuration of the information processing apparatus 10.

As illustrated in FIG. 1, the information processing apparatus 10 includes a central processing unit (CPU) 20, a read only memory (ROM) 22, a random access memory (RAM) 24, a storing unit 26, an input unit 28, a display 30, a detection unit 32, a photographing unit 34, and a communication unit 36. The CPU 20, the ROM 22, the RAM 24, the storing unit 26, the input unit 28, the display 30, the detection unit 32, the photographing unit 34, and the communication unit 36 are connected to one another such that they are able to communicate with one another via a bus 38. The CPU 20 is an example of a “processor”.

The CPU 20 is a central processing unit. The CPU 20 executes various programs and controls the units of the information processing apparatus 10. That is, the CPU 20 reads a program from the ROM 22 or the storing unit 26 and executes the program using the RAM 24 as an operation region. The CPU 20 performs control of the units of the information processing apparatus 10 and various types of calculation processing in accordance with the program recorded in the ROM 22 or the storing unit 26. In a first exemplary embodiment, an information processing program for displaying electronic information in an aspect that matches at least one of a use state of the electronic information and environmental information indicating the environment around a place where the electronic information is displayed is stored in the ROM 22 or the storing unit 26. The information processing program may be installed in advance in the information processing apparatus 10 or may be installed in the information processing apparatus 10 in an appropriate manner by being stored in a nonvolatile memory medium or being distributed via a network. The nonvolatile memory medium may be, for example, a compact disc-read only memory (CD-ROM), a magneto-optical disc, a hard disk drive (HDD), a digital versatile disc-read only memory (DVD-ROM), a flash memory, or a memory card.

The ROM 22 stores various programs and various data. The RAM 24 serves as an operation region and temporarily stores a program or data. The storing unit 26 is a memory device such as an HDD, a solid state drive (SSD), or a flash memory and stores various programs including an operating system and various data.

The input unit 28 is used for inputting various data. The display 30 is, for example, a liquid crystal display, and various types of information are displayed on the display 30. The display 30 is of a touch panel type and also functions as the input unit 28.

The detection unit 32 includes a plurality of sensors such as a contact sensor, a pressure sensor, an acceleration sensor, a gyroscope sensor, a humidity sensor, and a temperature sensor. The detection unit 32 may include other sensors in addition to the sensors mentioned above or may not include part of the sensors mentioned above.

The detection unit 32, which is an example of an acquisition unit, is capable of detecting at least one of the use state of electronic information and environmental information indicating the environment around a place where the electronic information is displayed. The use state of electronic information that may be detected by the detection unit 32 is, for example, internal temperature of the information processing apparatus 10. The environmental information that may be detected by the detection unit 32 is, for example, contact on the information processing apparatus 10, pressure and acceleration generated for the information processing apparatus 10, external temperature, which is temperature of space around the information processing apparatus 10, and humidity. Furthermore, “around a place where electronic information is displayed” may be defined in units of prefectures or municipalities in which the information processing apparatus 10 is located at the time when the electronic information is displayed or may be defined by a distance (for example, within 10 km range) from the current location of the information processing apparatus 10 at the time when the electronic information is displayed. The environmental information is not limited to information that may be detected by the detection unit 32 as described above and may include information that has been captured by the photographing unit 34, which will be described later, and information that may be acquired via the communication unit 36.

The photographing unit 34 is, for example, a camera including a solid-state imaging element such as a charge coupled device (CCD) or a complementary metal oxide semiconductor (CMOS).

The communication unit 36 is an interface that allows the information processing apparatus 10 to communicate with other apparatuses. For example, standards for wired communication such as Ethernet® or FDDI or standards for wireless communication such as 4G, 5G, or Wi-Fi® may be used for the communication using the interface.

In execution of the information processing program mentioned above, the information processing apparatus 10 performs processing based on the information processing program using the hardware resources mentioned above.

Next, an operation of the information processing apparatus 10 will be described.

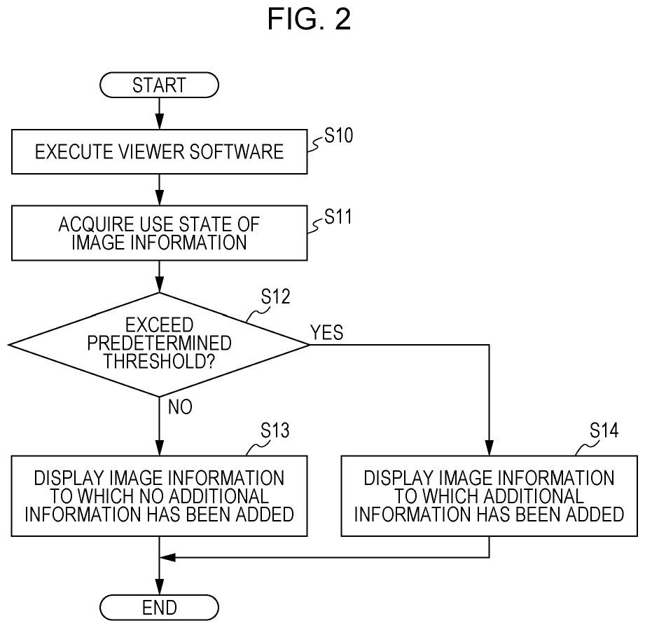

FIG. 2 is a flowchart illustrating a first flow of an electronic information display process performed by the information processing apparatus 10. The electronic information display process is performed when the CPU 20 reads an information processing program from the ROM 22 or the storing unit 26, loads the program onto the RAM 24, and executes the program.

In step S10 illustrated in FIG. 2, the CPU 20 executes, using viewer software, a file in which image information captured by the photographing unit 34 is stored. Then, the process proceeds to step S11. In the first exemplary embodiment, for example, “image information” is used as electronic information, and “viewer software” is used as specific software.

In step S11, the CPU 20 acquires a use state of the image information. Then, the process proceeds to step S12.

A use state of image information includes at least one of the number of browsing times that the image information has been browsed, the number of transfer times that the image information has been transferred, and the number of duplication times that the image information has been duplicated. The number of browsing times, the number of transfer times, and the number of duplication times are stored in the storing unit 26. Every time that the image information is browsed, transferred, or duplicated, the corresponding number of times stored in the storing unit 26 is updated. In step S11, for example, the CPU 20 acquires the “number of browsing times” as the use state of the image information from the storing unit 26.

In step S12, the CPU 20 determines whether or not the number of browsing times, as the use state of the image information, exceeds a predetermined threshold. In the case where it is determined that the number of browsing times does not exceed the predetermined threshold (step S12: No), the process proceeds to step S13. In contrast, in the case where CPU 20 determines that the number of browsing times exceeds the predetermined threshold (step S12: Yes), the process proceeds to step S14. In the first exemplary embodiment, in the case where the number of browsing times is less than or equal to 10, the CPU 20 determines that the number of browsing times does not exceed the predetermined threshold.

In step S13, the CPU 20 displays the image information to which no predetermined additional information has been added. Then, the CPU 20 ends the process. Details of the additional information will be described later.

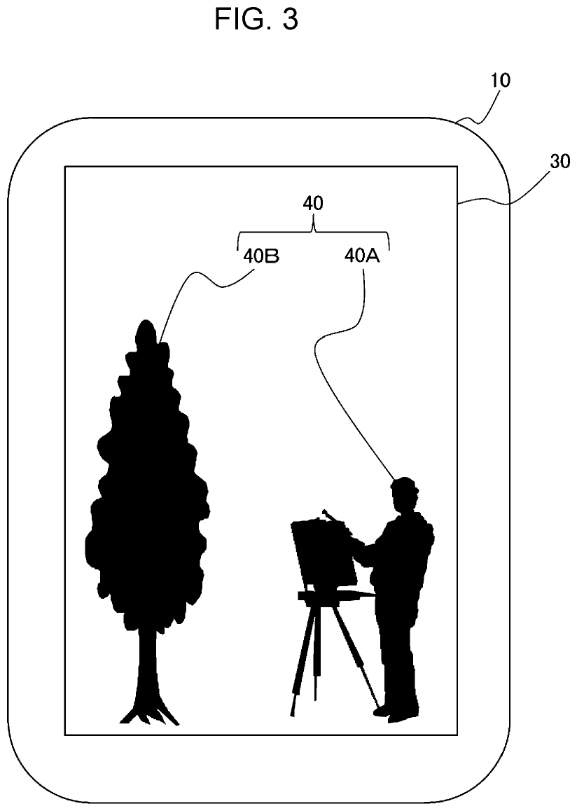

FIG. 3 illustrates a display example of image information to which no additional information has been added. As illustrated in FIG. 3, on the display 30, for example, a first image 40A including a person and a second image 40B including a tree, which configure a photographed image 40 captured by the photographing unit 34, are displayed in its original aspect as image information.

Referring back to FIG. 2, in step S14, the CPU 20 displays the image information to which additional information has been added. Then, the CPU 20 ends the process. The additional information represents information that provides a user of the information processing apparatus 10 with visual effects providing the impression that an object has been used. The additional information may be, for example, a scratch, dirt, crease, tear, distortion, dent, or the like.

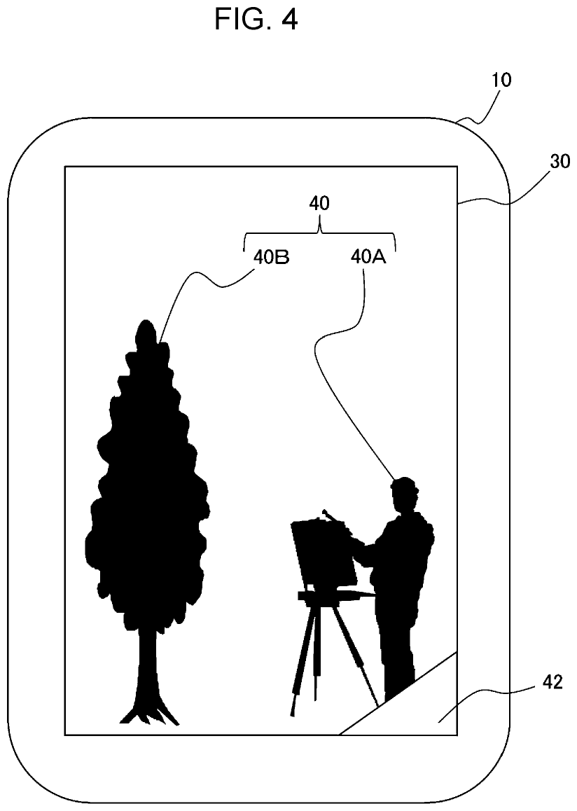

FIG. 4 illustrates a first display example of image information to which additional information has been added. As illustrated in FIG. 4, on the display 30, the photographed image 40 having the same content as that illustrated in FIG. 3 and a tear display 42 are displayed as image information. The tear display 42, which has a triangular shape, is displayed at a position that partially overlaps with the first image 40A of the photographed image 40. In the display example illustrated in FIG. 4, the photographed image 40 is information captured by the photographing unit 34, and the tear display 42 is information added as additional information using the viewer software.

In the first exemplary embodiment, because the CPU 20 performs control such that the tear display 42 is preferentially displayed in an overlap part in which the first image 40A and the tear display 42 overlap, only the tear display 42 is visible in the overlap part.

Furthermore, the CPU 20 displays the tear display 42 in the same color as the ground color of the display 30. Thus, in the display example illustrated in FIG. 4, because part of the first image 40A (in FIG. 4, legs of the person) is invisible in the overlap part, it is expected that the user will be given the impression that the displayed photograph has been torn off.

As described above, in the first exemplary embodiment, when executing the viewer software to display image information, the CPU 20 displays the image information in an aspect that matches a use state of the image information. Specifically, as a predetermined condition for executing the viewer software to display image information, the CPU 20 displays the image information to which additional information has been added, as an aspect that matches a use state of the image information in a case where the use state of the image information exceeds a predetermined threshold. In the first exemplary embodiment, a change that may occur in a photograph printed on photograph paper is reflected also in image information. For example, in the case where a certain part of the photograph is contacted by a user multiple times when the user browses the photograph multiple times, the certain part may get dirty because of fingerprints of the user. In the first exemplary embodiment, such a change that may occur in a photograph is reflected also in image information by adding the change as additional information, which is information that provides the user of the information processing apparatus 10 with visual effects providing the impression that the photograph has been used.

Thus, in the first exemplary embodiment, an aspect of display of image information may be changed. In the first exemplary embodiment, as an aspect of image information to be displayed, a change to an aspect in which additional information has been added may be made.

In the first exemplary embodiment, in step S11, the “number of browsing times” is acquired as the use state of the image information from the storing unit 26. However, the use state of the image information acquired in step S11 is not necessarily the “number of browsing times”. In step S11, at least one of the number of browsing times, the number of transfer times, and the number of duplication times may be acquired as the use state of image information. For example, the number of transfer times may be acquired, or both the number of browsing times and the number of transfer times may be acquired.

In the first exemplary embodiment, the tear display 42 as additional information is superimposed on the photographed image 40, and part of the first image 40A (in FIG. 4, legs of the person) that corresponds to the overlap part in which the tear display 42 and the photographed image 40 overlap is thus made invisible. However, part of the first image 40A is not necessarily made invisible by superimposing additional information on the photographed image 40 as described above. Part of the photographed image 40 may be deleted as provision of additional information, so that part of the first image 40A (in FIG. 4, legs of the person) that corresponds to the deleted part is made invisible. That is, addition of additional information is not necessarily performed by superimposing another image on the photographed image 40 but may be performed by deleting part of the photographed image 40.

### Second Exemplary Embodiment

Next, a second exemplary embodiment will be described. Description that overlaps with other exemplary embodiments will be omitted or simplified.

In the second exemplary embodiment, a plurality of levels of predetermined thresholds for a use state of image information are provided, unlike the first exemplary embodiment. Specifically, two levels of thresholds: a first threshold and a second threshold that is larger than the first threshold, are provided. In the second exemplary embodiment, “ten times” is set as the first threshold, and “twenty times” is set as the second threshold. In the second exemplary embodiment, as the level of the threshold exceeded increases, the CPU 20 increases the degree to which an aspect of image information to be displayed is changed from an aspect before additional information is added.

For example, in the second exemplary embodiment, in the case where the CPU 20 determines in step S12 that the use state of the image information (for example, the number of browsing times) is more than the first threshold and less than or equal to the second threshold, the CPU 20 displays the image information in the aspect illustrated in FIG. 4. That is, in this case, the image information is displayed in the aspect in which the tear display 42 has been added as additional information (see FIG. 4).

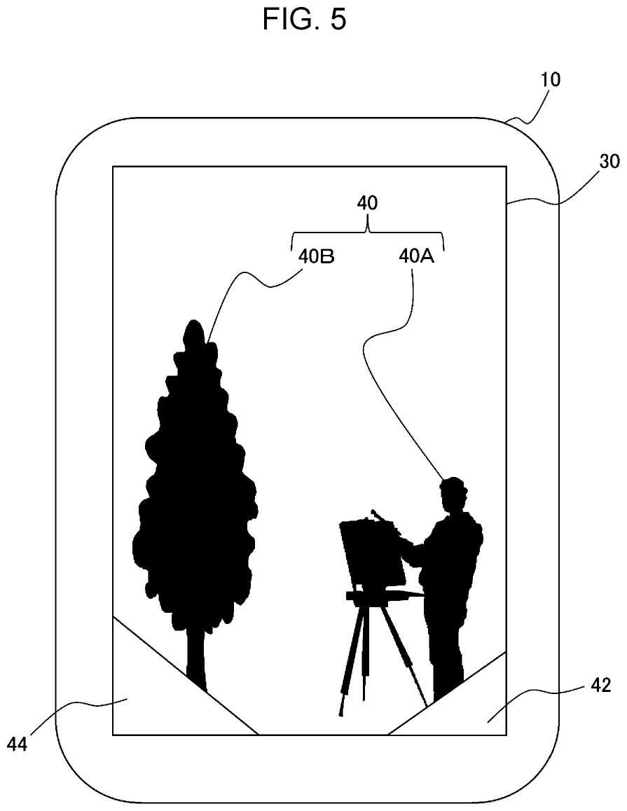

In the second exemplary embodiment, in the case where the CPU 20 determines in step S12 that the use state of the image information (for example, the number of browsing times) is more than the second threshold, the CPU 20 displays the image information in an aspect illustrated in FIG. 5.

FIG. 5 illustrates a second display example of image information to which additional information has been added. As illustrated in FIG. 5, on the display 30, the photographed image 40 having the same content as that illustrated in FIGS. 3 and 4, the tear display 42, and a tear display 44 are displayed as image information. The tear display 44, which has a triangular shape, is displayed at a position that partially overlaps with the second image 40B of the photographed image 40. In the display example illustrated in FIG. 5, the photographed image 40 is information captured by the photographing unit 34, and the tear display 42 and the tear display 44 are information added as additional information using the viewer software.

As with the overlap part in which the first image 40A and the tear display 42 overlap (hereinafter, referred to as a “first overlap part”), because the CPU 20 performs control such that the tear display 44 is preferentially displayed in an overlap part in which the second image 40B and the tear display 44 overlap (hereinafter, referred to as a “second overlap part”), only the tear display 44 is visible in the second overlap part. Furthermore, the CPU 20 displays the tear display 44 in the same color as the ground color of the display 30. Thus, in the display example illustrated in FIG. 5, because part of the first image 40A (in FIG. 5, legs of the person) is invisible in the first overlap part and part of the second image 40B (in FIG. 5, the root of the tree) is invisible in the second overlap part, it is expected that the user will be given the impression that a plurality of parts of the displayed photograph has been torn off.

As described above, in the second exemplary embodiment, a plurality of levels of predetermined thresholds for a use state of image information are provided, and as the level of the predetermined threshold exceeded increases, the number of tear displays provided increases. The area of the photographed image 40 that is visible on the display 30 decreases, and the degree to which image information to be displayed is changed thus increases. Accordingly, in the second exemplary embodiment, an aspect of display of image information may be changed in stages, compared to the configuration in which a single level of threshold is provided.

In the second exemplary embodiment, two levels of thresholds: the first threshold and the second threshold, are provided as a plurality of levels of thresholds. However, two levels of thresholds are not necessarily provided. Three or more levels of thresholds may be provided.

In the second exemplary embodiment, the tear display 44 as additional information is superimposed on the photographed image 40, and part of the second image 40B (in FIG. 5, the root of the tree) that corresponds to the overlap part in which the tear display 44 and the photographed image 40 overlap is thus made invisible. However, part of the second image 40B is not necessarily made invisible by superimposing additional information on the photographed image 40 as described above. Part of the photographed image 40 may be deleted as provision of additional information, so that part of the second image 40B (in FIG. 5, the root of the tree) that corresponds to the deleted part is made invisible.

### Third Exemplary Embodiment

Next, a third exemplary embodiment will be described. Description that overlaps with other exemplary embodiments will be omitted or simplified.

In the third exemplary embodiment, in the case where specific software is executed so that electronic information is displayed, the CPU 20 displays the electronic information in an aspect that matches environmental information, unlike the exemplary embodiments described above. Information that may be acquired via the communication unit 36, specifically, weather information, which will be described later, is used as the environmental information in the third exemplary embodiment.

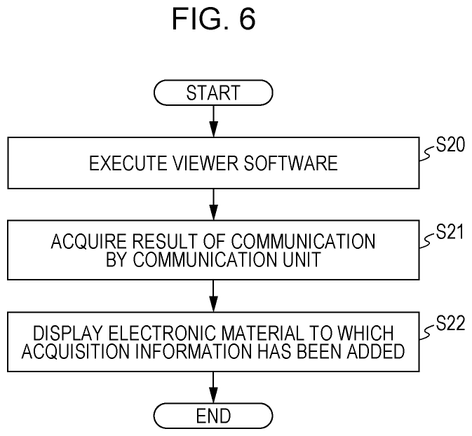

FIG. 6 is a flowchart illustrating a second flow of the electronic information display process performed by the information processing apparatus 10.

In step S20 in FIG. 6, the CPU 20 executes, using the viewer software, a file in which electronic material created using presentation software is stored. Then, the process proceeds to step S21. In the third exemplary embodiment, for example, “electronic material” is used as electronic information, and “viewer software” is used as specific software.

In step S21, the CPU 20 acquires a result of communication by the communication unit 36. Then, the process proceeds to step S22. In the third exemplary embodiment, the CPU 20 acquires, as the result of communication by the communication unit 36, weather information within a range of five kilometers from a place where electronic material received from a weather server via the communication unit 36 is displayed. The place where the electronic material is displayed is determined based on global positioning system (GPS) information of the information processing apparatus 10. Furthermore, the communication unit 36 is an example of an “acquisition unit”, and the result of communication is an example of a “result of acquisition”.

In step S22, the CPU 20 displays the electronic material to which the acquisition information that matches the result of communication by the communication unit 36 has been added. Then, the CPU 20 ends the process.

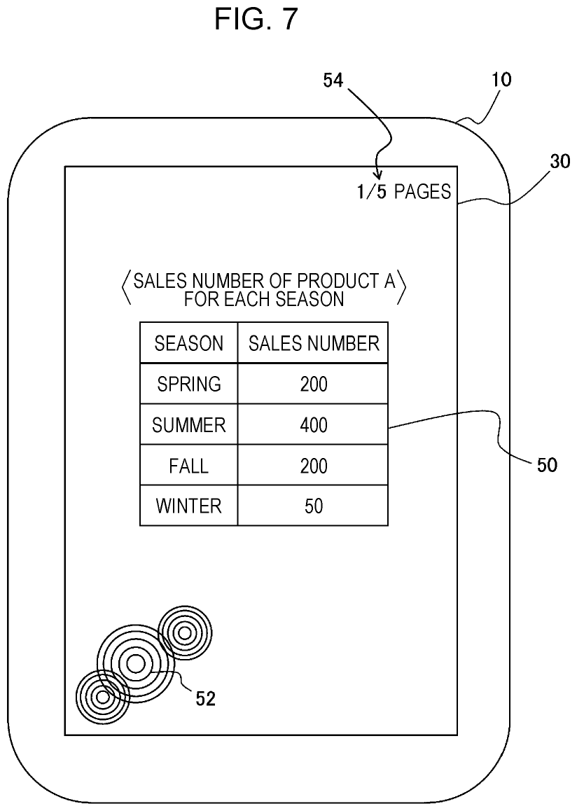

FIG. 7 illustrates a first display example of electronic material to which acquisition information has been added. As illustrated in FIG. 7, on the display 30, a first material image 50, a raindrop display 52, and a page number display 54 are provided as electronic material. The first material image 50 indicates the “sales number of product A for each season” in a table format. The raindrop display 52 including a plurality of ripples is displayed in a lower left part of the display 30. The page number display 54 indicating a page number is displayed in an upper right part of the display 30. In FIG. 7, “1/5 pages” is displayed. In the display example illustrated in FIG. 7, the first material image 50 and the page number display 54 are information created using presentation software, and the raindrop display 52 is information added as acquisition information using the viewer software.

In the third exemplary embodiment, in the case where the weather information acquired in step S21 indicates rain, the CPU 20 displays the electronic material to which the raindrop display 52 has been added. Thus, in the third exemplary embodiment, it is expected that the user who browses the display example illustrated in FIG. 7 will be able to recognize that the weather around the place where the user is browsing the electronic material is rain.

As described above, in the third exemplary embodiment, when executing the viewer software to display electronic material, the CPU 20 displays the electronic material to which acquisition information that matches a result of communication by the communication unit 36 has been added. Thus, in the third exemplary embodiment, an aspect of electronic material to be displayed is changed to an aspect in which acquisition information has been added to the electronic material. In the third exemplary embodiment, a change that may occur in paper material is reflected also in electronic material. For example, in the case where a user browses paper material outside in rain, the paper material may get wet by rain. In the third exemplary embodiment, such a change that may occur in paper material is reflected also in electronic material by adding the raindrop display 52 as acquisition information.

Furthermore, in the third exemplary embodiment, by adding acquisition information, the CPU 20 changes the aspect of the entire electronic material to be displayed from an aspect before the acquisition information is added.

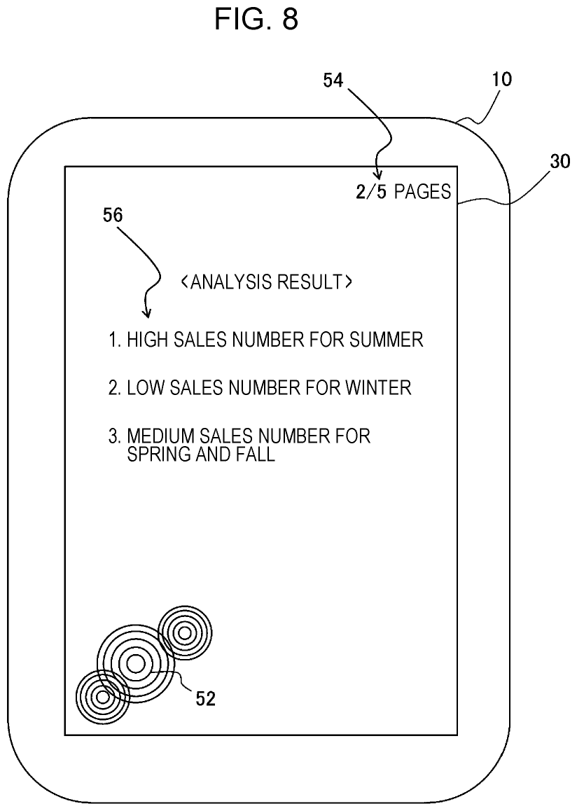

FIG. 8 illustrates a second display example of electronic material to which acquisition information has been added. As illustrated in FIG. 8, on the display 30, a second material image 56, the raindrop display 52, and the page number display 54 are displayed as electronic material. The second material image 56 indicates an “analysis result” regarding the “sales number of product A for each season”. In the display example in FIG. 8, the second material image 56 and the page number display 54 are information created using the presentation software, and the raindrop display 52 is information added as acquisition information using the viewer software.

As the page number display 54 illustrated in FIG. 8, “2/5 pages”, which indicates the page subsequent to that in the display example illustrated in FIG. 7, is provided. Furthermore, in the display example illustrated in FIG. 8, as the page changes, display content at the center of the display 30 is changed from the first material image 50 (see FIG. 7) to the second material image 56. However, in the display example illustrated in FIG. 8, even with the page change, the same raindrop display 52 as that in the display example illustrated in FIG. 7 is provided.

That is, in the third exemplary embodiment, in the case where the CPU 20 displays electronic material to which acquisition information has been added, the CPU 20 displays the raindrop display 52 as acquisition information in all the pages of the electronic material. Although illustration of display examples for “3/5 pages” and following pages is omitted, the raindrop display 52 is also displayed in these pages in the third exemplary embodiment.

With the configuration described above, in the third exemplary embodiment, a user is able to easily recognize the environment around the place where the user is browsing electronic material, compared to a configuration in which an aspect of part of electronic material to be displayed is changed.

In the third exemplary embodiment, only information regarding weather such as “rain” is acquired as weather information. However, the weather information acquired in the third exemplary embodiment is not necessarily “information regarding weather”. Specifically, weather information is not only information regarding weather such as “rain” or “fine” but also information such as temperature, humidity, wind speed, or the like. In the third exemplary embodiment, as weather information, at least one of the types of information mentioned above may be acquired. For example, information of temperature may be acquired, or information of temperature and humidity may be acquired.

In the third exemplary embodiment, electronic material to which the raindrop display 52 has been added is displayed, so that a user is provided with a hint of the weather around the place where the user is browsing the electronic material. However, a hint of the weather is not necessarily provided in the method mentioned above. For example, the CPU 20 may add, as acquisition information, color corresponding to weather information, in place of or in addition to the raindrop display 52, on the display 30. Specifically, in the case where the weather information acquired in step S21 indicates rain, the CPU 20 may display, as acquisition information, the background of the display 30 in “blue”. In the case where the weather information acquired in step S21 is fine, the CPU 20 may display, as acquisition information, the background of the display 30 in red. As described above, the user may be provided with a hint of the weather around the place where the user is browsing the electronic material, in accordance with color of the background of the display 30. Furthermore, in the case where the weather information acquired in step S21 indicates rain, the CPU 20 may change an aspect of display of figures, characters, or the like in the electronic material such that an impression that the electronic material is damp and soft is given to the user.

Furthermore, in the third exemplary embodiment, by changing the speed of turning pages of electronic material, the user may be provided with a hint of the temperature around the place where the user is browsing the electronic material. For example, in the case where the temperature acquired based on weather information is lower than or equal to a predetermined temperature (0 degrees Celsius), the speed of turning pages of the electronic material may be lower than the case where the temperature acquired based on the weather information exceeds the predetermined temperature (0 degrees Celsius). In a similar manner, the number of pages turned in accordance with a page-turn instruction may be changed. For example, in the case where electronic material is displayed when weather information indicates rain and the environment around the place where the user is browsing the electronic material is wet, more pages may be turned than a case where the electronic material is displayed when weather information indicates fine and the environment around the place where the user is browsing the electronic material is dry. As described above, it is expected that the user will be given the impression that a plurality of pages are turned at a time due to wetting by rain.

In the third exemplary embodiment, providing the raindrop display 52 as acquisition information in all the pages of electronic material is an example of a “change in an aspect of the entire electronic material”. However, an example of a “change in an aspect of the entire electronic material” is not limited to the above example. For example, an example of a “change in an aspect of the entire electronic material” may be changing the color of the background of a whole page of electronic material being browsed as acquisition information.

### Fourth Exemplary Embodiment

Next, a fourth exemplary embodiment will be described. Description that overlaps with other exemplary embodiments will be omitted or simplified.

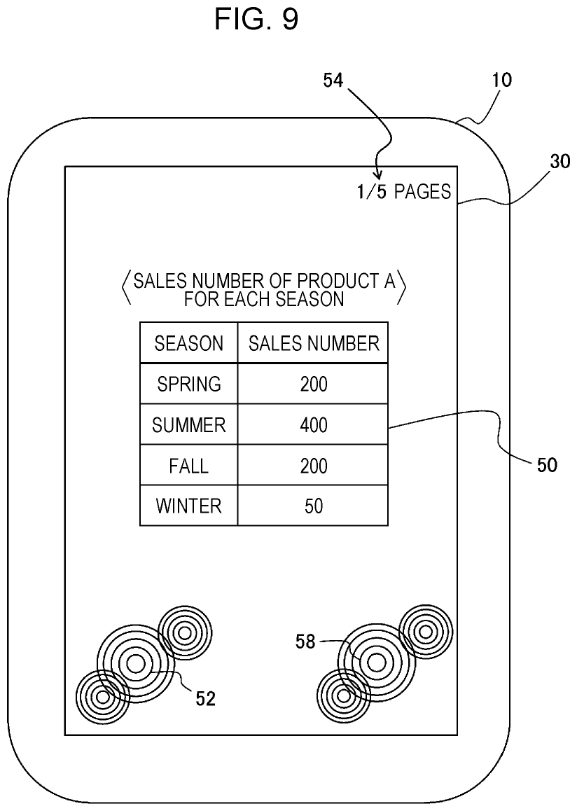

FIG. 9 illustrates a third display example of electronic material to which acquisition information has been added. As illustrated in FIG. 9, on the display 30, the first material image 50 having the same content as that illustrated in FIG. 7, the page number display 54, the raindrop display 52, and a raindrop display 58 are displayed as electronic material. The raindrop display 58 including a plurality of ripples is provided in a lower right part of the display 30. In the display example illustrated in FIG. 9, the first material image 50 and the page number display 54 are information created using presentation software, and the raindrop display 52 and the raindrop display 58 are information added as acquisition information using viewer software.

In the fourth exemplary embodiment, the CPU 20 changes the degree to which an aspect of electronic material to be displayed is changed from an aspect before acquisition information is added, in accordance with an acquisition time of weather information acquired via the communication unit 36. Specifically, in the case where weather information acquired via the communication unit 36 has not changed for a predetermined time (for example, ten minutes), the CPU 20 changes the degree to which the aspect of electronic material to be displayed is changed, by increasing the number of raindrop displays to be displayed.

For example, in the case where weather information acquired at time T1 indicates rain, the CPU 20 displays electronic material to which the raindrop display 52 has been added (see FIG. 7). Furthermore, in the case where weather information acquired up to time T2, which is the time when the predetermined time (for example, ten minutes) has passed since the time T1, indicates rain, the CPU 20 displays the electronic material to which the raindrop display 58 has further been added (see FIG. 9).

With the configuration described above, in the fourth exemplary embodiment, the degree to which an aspect of electronic material to be displayed is changed from an aspect before acquisition information is added may be changed in accordance with the acquisition time of weather information acquired via the communication unit 36.

In the fourth exemplary embodiment, the acquisition time of weather information is determined on the basis of a time for which a specific phenomenon such as “there has been no change in weather information for a predetermined time (for example, ten minutes)” has been occurring. However, the acquisition time of weather information is not necessarily determined as described above and may be determined on the basis of the cumulative duration of a specific phenomenon. For example, in the case where weather information such as “it has rained for ten minutes out of thirty minutes” is acquired, the degree to which electronic material to be displayed is changed may be changed, by determining that the cumulative duration of rain has reached a predetermined time (for example, ten minutes) even if the period for which it has been raining continuously is less than the predetermined time.

### Fifth Exemplary Embodiment

Next, a fifth exemplary embodiment will be described. Description that overlaps with other exemplary embodiments will be omitted or simplified.

In the fifth exemplary embodiment, the electronic information display process based on the flowchart illustrated in FIG. 6 is performed as in the third exemplary embodiment. However, the electronic information display process performed in the fifth exemplary embodiment is different from that in the third exemplary embodiment in a result of communication by the communication unit 36 in step S21. In the fifth exemplary embodiment, information that may be acquired via the communication unit 36, specifically, GPS information, which will be described later, is used as environmental information.

In the fifth exemplary embodiment, in step S21 in FIG. 6, the CPU 20 acquires, via GPS communication, GPS information of the information processing apparatus 10, as a result of communication by the communication unit 36.

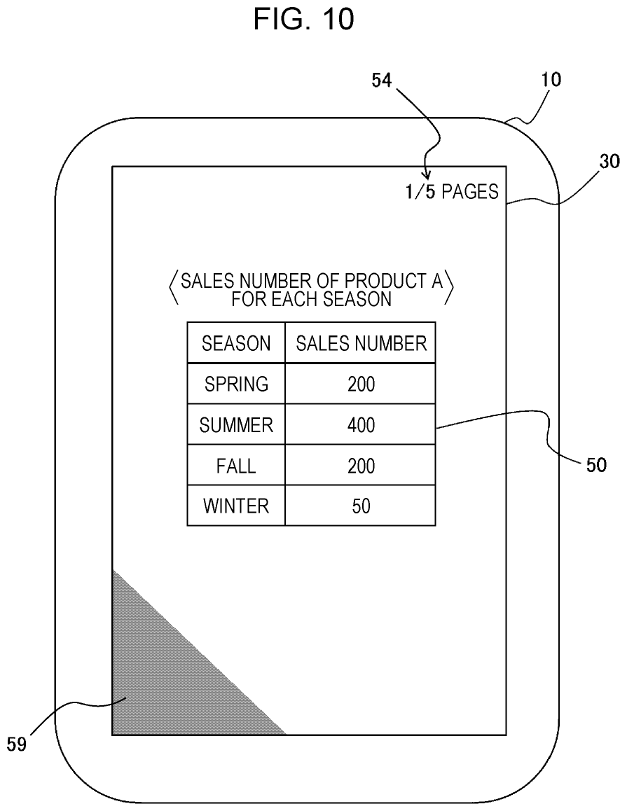

FIG. 10 illustrates a fourth display example of electronic material to which acquisition information has been added. As illustrated in FIG. 10, on the display 30, the first material image 50 having the same content as that illustrated in FIG. 7, the page number display 54, and a shadow display 59 are displayed as electronic material. The shadow display 59, which has a triangular shape, is provided in a lower left part of the display 30. In the display example illustrated in FIG. 10, the first material image 50 and the page number display 54 are information created using presentation software, and the shadow display 59 is information added as acquisition information using viewer software.

In the fifth exemplary embodiment, the CPU 20 provides the shadow display 59 in a color different from the ground color of the display 30 to represent a shadow. Thus, in the display example illustrated in FIG. 10, with provision of the shadow display 59, it is expected that a user will be given the impression that the displayed material has a shadow on it.

In the fifth exemplary embodiment, a change that may occur in paper material is reflected also in electronic material. For example, in the case where a user browses paper material outside on sunny day, a shadow may be produced on the paper material. In the fifth exemplary embodiment, such a change that may occur in paper material is reflected also in electronic material, by adding the shadow display 59 as acquisition information.

In the fifth exemplary embodiment, the CPU 20 provides the shadow display 59 on the basis of GPS information of the information processing apparatus 10. However, the shadow display 59 may be provided on the basis of other elements in place of or in addition to GPS information. Examples of the other elements include time at which a user is browsing electronic material, image information captured by the photographing unit 34, and the like.

### Sixth Exemplary Embodiment

Next, a sixth exemplary embodiment will be described. Description that overlaps with other exemplary embodiments will be omitted or simplified.

In the sixth exemplary embodiment, when executing specific software to display electronic information, the CPU 20 displays the electronic information to which acquisition information that matches a result of detection by the detection unit 32 has been added, unlike the exemplary embodiments described above. In the sixth exemplary embodiment, information that may be detected by the detection unit 32, specifically, presence or absence of contact on the display 30 from the outside, which will be described later, is used as environmental information. The detection unit 32 is an example of an “acquisition unit”, and a result of detection is an example of a “result of acquisition”.

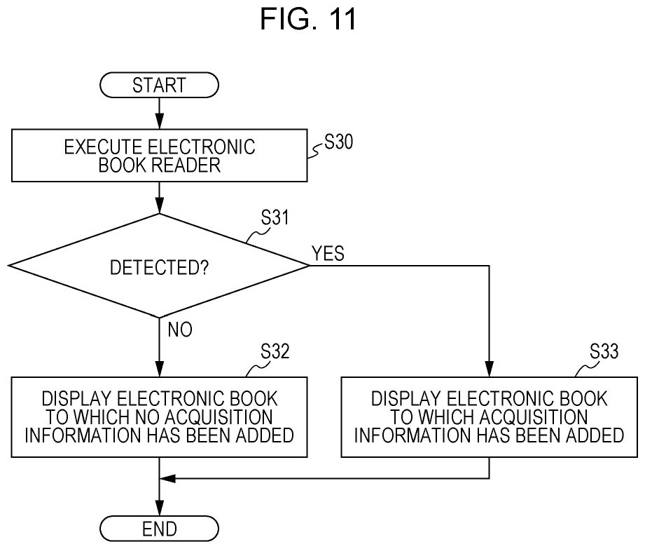

FIG. 11 is a flowchart illustrating a third flow of the electronic information display process performed by the information processing apparatus 10.

In step S30 illustrated in FIG. 11, the CPU 20 executes, with an electronic book reader, a file in which an electronic book distributed from a content distribution server is stored. Then, process proceeds to step S31. In the sixth exemplary embodiment, for example, an “electronic book” is used as electronic information, and an “electronic book reader” is used as specific software.

In step S31, the CPU 20 determines whether or not something has been detected by the detection unit 32. In the case where the CPU 20 determines that nothing has been detected (step S31: No), the CPU 20 proceeds to step S32. In contrast, in the case where the CPU 20 determines that something has been detected (step S31: Yes), the CPU 20 proceeds to step S33.

In step S32, the CPU 20 displays the electronic book to which no acquisition information has been added. Then, the CPU 20 ends the process.

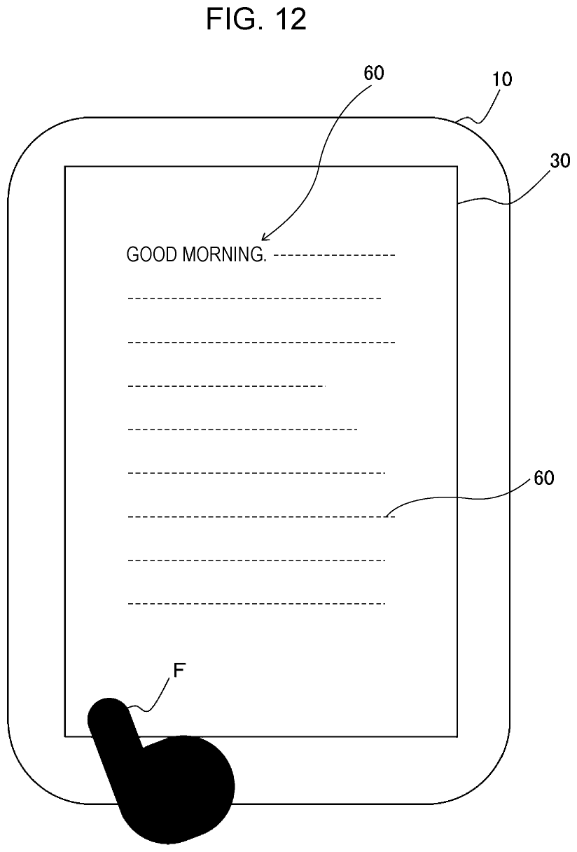

FIG. 12 illustrates a first display example of an electronic book to which no acquisition information has been added. As illustrated in FIG. 12, on the display 30, a text display 60 indicating text of an electronic book is displayed in its original aspect as an electronic book. In FIG. 12, the text display 60 includes characters “Good morning.” and broken lines, which are not characters. Furthermore, in FIG. 12, a finger display F schematically indicating a finger of a user is illustrated.

Referring back to FIG. 11, in step S33, the CPU 20 displays the electronic book to which acquisition information has been added. Then, the CPU 20 ends the process.

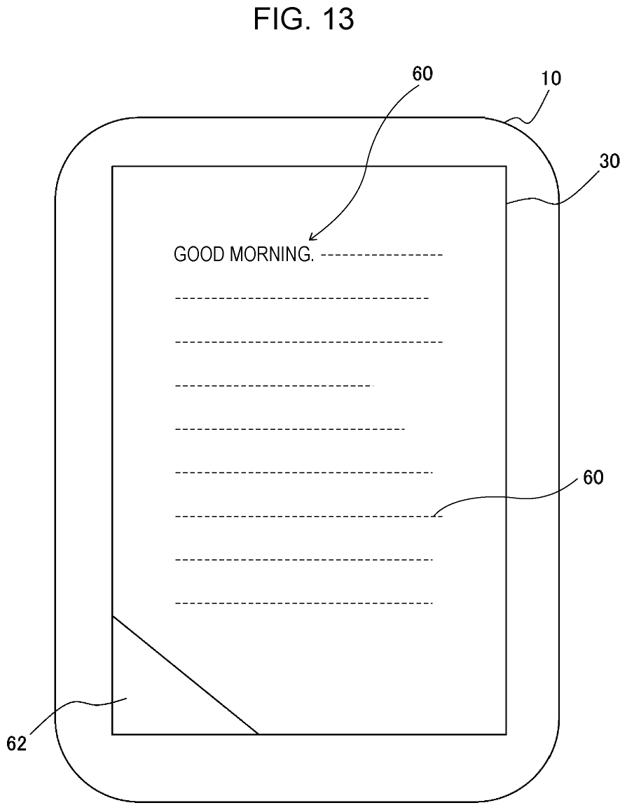

FIG. 13 illustrates a first display example of an electronic book to which acquisition information has been added. As illustrated in FIG. 13, on the display 30, the text display 60 having the same content as that illustrated in FIG. 12 and a tear display 62 are displayed as an electronic book. The tear display 62, which has a triangular shape, is provided in a lower left part of the display 30. In the display example illustrated in FIG. 13, the text display 60 is information distributed from the content distribution server, and the tear display 62 is information added as acquisition information using the electronic book reader.

The tear display 62 is provided when contact on the display 30 from the outside is detected by the detection unit 32. For example, in the display example illustrated in FIG. 13, when a finger of a user is in contact with the lower left part of the display 30 in the state in the display example illustrated in FIG. 12, the contact is detected by the detection unit 32, and the CPU 20 displays an electronic book to which the tear display 62 that matches a result of detection by the detection unit 32 has been added.

In the sixth exemplary embodiment, a plurality of detection regions for which the detection unit 32 performs detection of contact on the display 30 are provided in the display 30. For example, it is assumed that the detection regions include six detection region: a first detection region, which is a region in an upper left part of the display 30, a second detection region, which is a region in an upper right part of the display 30, a third detection region, which is a region in a central left part of the display 30, a fourth detection region, which is a region in a central right part of the display 30, a fifth detection region, which is a region in a lower left part of the display 30, and a sixth detection region, which is a region in a lower right part of the display 30.

The CPU 20 provides the tear display 62 at a position corresponding to a detection region in which contact on the display 30 has been detected by the detection unit 32. For example, FIG. 13 illustrates a display example of a case where a finger of a user is in contact with the fifth detection region, and the CPU 20 displays an electronic book to which the tear display 62 has been added to the lower left part of the display 30 in this display example. Furthermore, in the sixth exemplary embodiment, although illustration is omitted, for example, when a finger of a user is in contact with the sixth detection region in the state in the display example illustrated in FIG. 13, the CPU 20 further provides another tear display in the lower right part of the display 30. In the sixth exemplary embodiment, the tear display 62 is provided only in a page displayed when the CPU 20 determines in step S31 illustrated in FIG. 11 that something has been detected, and no tear display 62 is provided in the subsequent pages.

As described above, in the sixth exemplary embodiment, by adding acquisition information, the CPU 20 changes an aspect of part of an electronic book to be displayed from an aspect before the acquisition information is added. Thus, in the sixth exemplary embodiment, compared to the configuration in which an aspect of the entire electronic book to be displayed is changed, the range of an electronic book to be displayed in which an aspect is changed may be limited.

In the sixth exemplary embodiment, the tear display 62 is provided as acquisition information in an electronic book, so that part of the electronic book that corresponds to the part in which the tear display 62 is provided is made invisible, as in the exemplary embodiments described above. However, part of an electronic book is not necessarily made invisible by displaying acquisition information in the electronic book as described above. Part of an electronic book may be deleted as provision of acquisition information, so that part of the electronic book that corresponds to the deleted part is made invisible. That is, addition of acquisition information is not necessarily performed by superimposing another image on part of an electronic book but may be performed by deleting part of the electronic book.

In the sixth exemplary embodiment, providing the tear display 62 as acquisition information only in a page displayed when the CPU 20 determines in step S31 illustrated in FIG. 11 that something has been detected is an example of a “change in an aspect of part of electronic information”. However, a “change in an aspect of part of electronic information” is not limited to the example mentioned above. For example, even if acquisition information is displayed in all the pages of an electronic book, changing an aspect of part of a page, such as the tear display 62, may also be an example of a “change in an aspect of part of electronic information”.

In the sixth exemplary embodiment, the tear display 62 is provided when contact on the display 30 from the outside is detected by the detection unit 32. However, the detection unit 32 may further detect pressure based on the contact and change the degree to which an aspect of an electronic book is changed from an aspect before acquisition information is added, in accordance with the detected pressure. For example, the area, shape, and the like of the tear display 62 to be displayed may be made different between a case where the pressure detected by the detection unit 32 is equal to or more than a predetermined threshold and a case where the pressure is less than the threshold.

### Seventh Exemplary Embodiment

Next, a seventh exemplary embodiment will be described. Description that overlaps with other exemplary embodiments will be omitted or simplified.

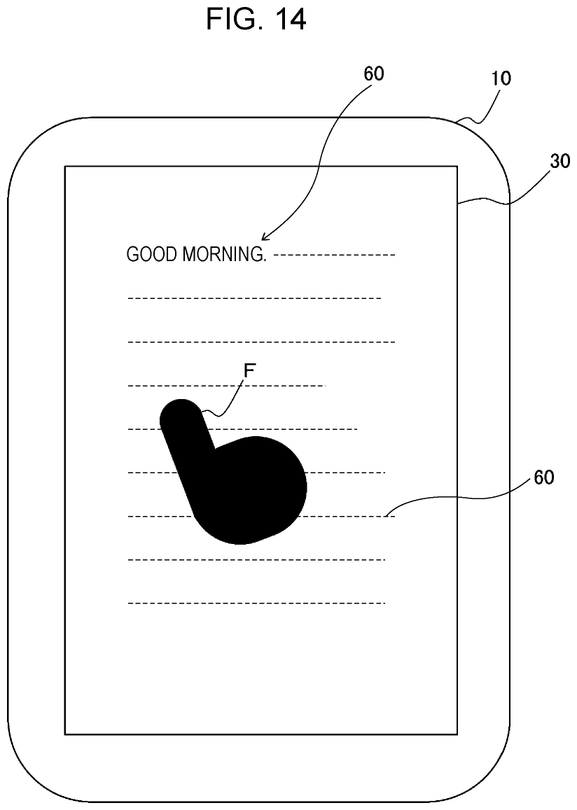

FIG. 14 illustrates a second display example of an electronic book to which no acquisition information has been added. As illustrated in FIG. 14, on the display 30, the text display 60 having the same content as that illustrated in FIG. 12 is displayed in its original aspect as an electronic book. In FIG. 14, the finger display F is provided in a central left part of the display 30 and thus indicates that a finger of a user is in contact with the third detection region, which is a region in the central left part of the display 30.

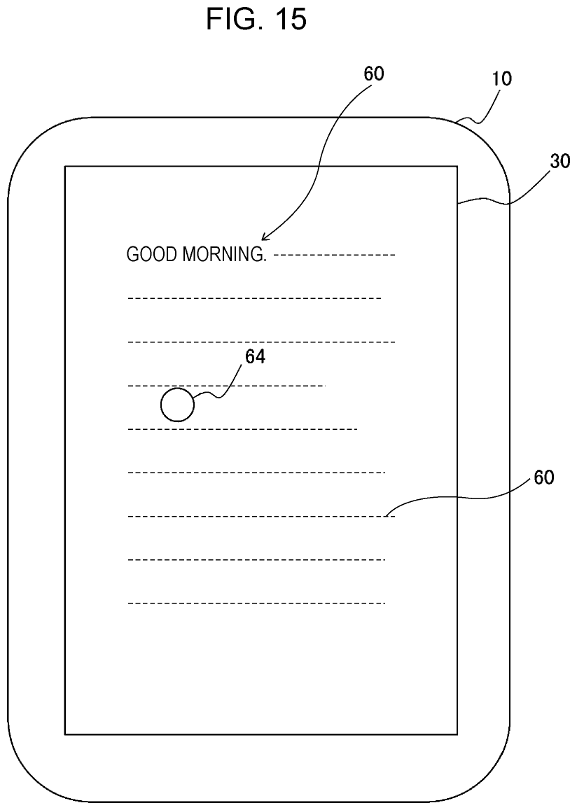

FIG. 15 illustrates a second display example of an electronic book to which acquisition information has been added. As illustrated in FIG. 15, on the display 30, the text display 60 having the same content as that illustrated in FIG. 14 and a tear display 64 are displayed as an electronic book. The tear display 64, which has a circular shape, is provided in a central left part of the display 30. In the display example illustrated in FIG. 15, the text display 60 is information distributed from a content distribution server, and the tear display 64 is information added as acquisition information using an electronic book reader.

In the seventh exemplary embodiment, in the case where contact on the display 30, as generation of environmental information on the display 30, is detected by the detection unit 32, the CPU 20 changes the degree to which an aspect of an electronic book to be displayed is changed from an aspect before acquisition information is added, in accordance with the position on the display 30 at which contact on the display 30 has been detected by the detection unit 32.

For example, in the seventh exemplary embodiment, when a finger of a user is in contact with the fifth detection region, which is a region in a lower left part of the display 30, the CPU 20 provides the tear display 62 in the lower left part of the display 30 (see FIG. 13), as in the sixth exemplary embodiment. Furthermore, in the seventh exemplary embodiment, when a finer of a user is in contact with the third detection region, which is a region in a central left part of the display 30, the CPU 20 provides the tear display 64 in the central left part of the display 30 (see FIG. 15).

In the seventh exemplary embodiment, the degree to which an electronic book to be displayed is changed is changed, by causing the tear display 62 to be displayed in the case where contact on the fifth detection region is detected by the detection unit 32 and the tear display 64 displayed in the case where contact on the third detection region is detected by the detection unit 32 to have different areas and shapes.

With the configuration described above, in the seventh exemplary embodiment, the degree to which an aspect of an electronic book to be displayed is changed from an aspect before acquisition information is added may be changed, in accordance with a position on the display 30 at which contact on the display 30 has been detected by the detection unit 32.

In the seventh exemplary embodiment, a change that may occur in a bound book is reflected also in an electronic book. For example, for bound books, an end part of paper may be easily torn off, but a central part of paper may be less likely to be torn off than an end part of paper. In the seventh exemplary embodiment, such a change that may occur in a bound book is reflected also in an electronic book, by changing the degree to which an electronic book to be displayed is changed, in accordance with a position on the display 30 at which contact on the display 30 has been detected by the detection unit 32.

Also in the seventh exemplary embodiment, the tear display 64 is provided as acquisition information in an electronic book, so that part of the electronic book that corresponds to the part in which the tear display 64 is provided is made invisible, as in the exemplary embodiments described above. However, part of an electronic book is not necessarily made invisible by displaying acquisition information in the electronic book as described above. Part of an electronic book may be deleted as provision of acquisition information, so that part of the electronic book that corresponds to the deleted part is made invisible.

### Eighth Exemplary Embodiment

Next, an eighth exemplary embodiment will be described. Description that overlaps with other exemplary embodiments will be omitted or simplified.

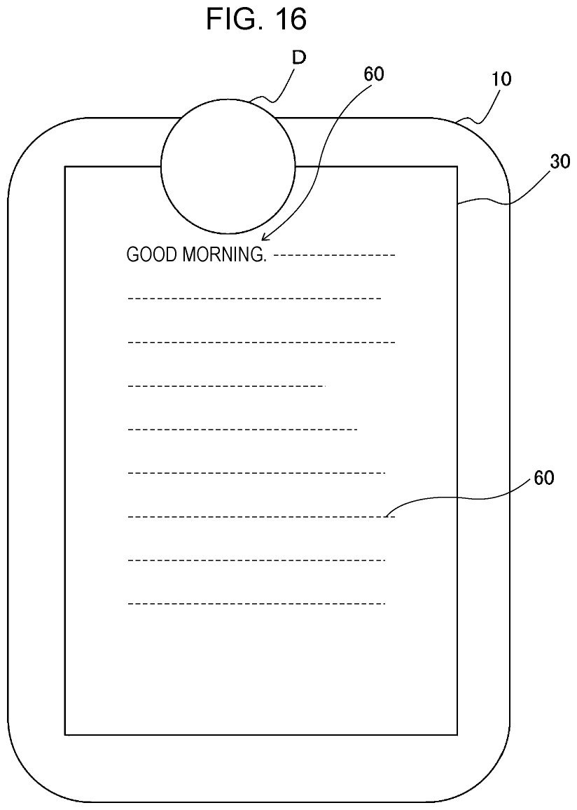

FIG. 16 illustrates a third display example of an electronic book to which no acquisition information has been added. As illustrated in FIG. 16, on the display 30, the text display 60 having the same content as that illustrated in FIG. 12 is displayed in its original aspect as an electronic book. Furthermore, in FIG. 16, a canned drink D containing hot drink is placed in an upper part of the display 30.

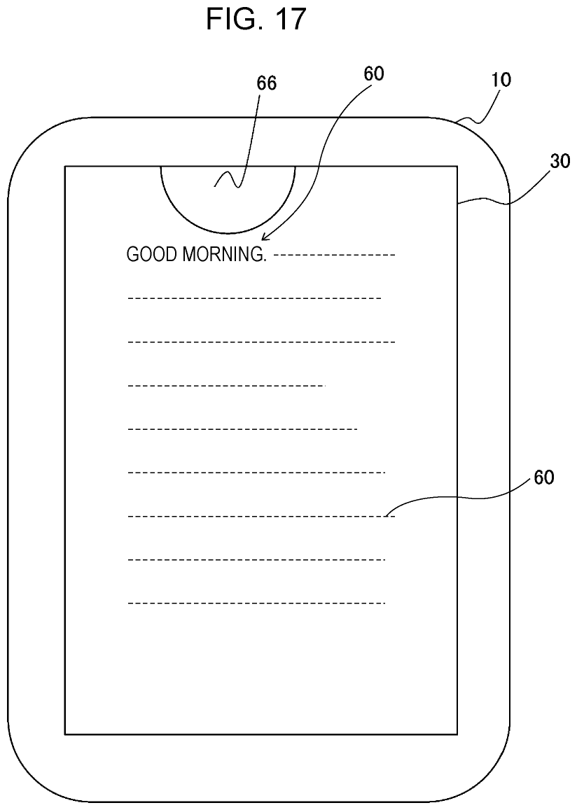

FIG. 17 illustrates a third display example of an electronic book to which acquisition information has been added. As illustrated in FIG. 17, on the display 30, the text display 60 having the same content as that illustrated in FIG. 16 and a mark display 66 are displayed as an electronic book. The mark display 66, which has a semicircular shape, is provided in an upper part of the display 30. In the display example illustrated in FIG. 17, the text display 60 is information distributed from a content distribution server, and the mark display 66 is information added as acquisition information using an electronic book reader.

In the eighth exemplary embodiment, the CPU 20 displays, as the mark display 66, which is a mark of the canned drink D, only part of the canned drink D placed in FIG. 16 that overlaps with the display 30. Thus, in the display example illustrated in FIG. 17, with provision of the mark display 66, it is expected that a user will be given the impression that the mark of the canned drink D is provided on the electronic book being displayed.

Processing of the CPU 20 for determining whether or not to provide the mark display 66 may be implemented, for example, as described below.

For example, the CPU 20 determines, on the basis of temperature of an object (hereinafter, referred to as “object temperature”) that is in contact with the display 30, the temperature being detected by the detection unit 32, whether or not to display the mark display 66, which is a mark of the canned drink D. In the case where the object temperature is within a predetermined range (for example, from 35 degrees Celsius to 40 degrees Celsius), the CPU 20 determines that a finger of a user is in contact with the display 30 and does not display a mark of the object that is in contact with the display 30. In contrast, in the case where the object temperature is outside the predetermined range (for example, 10 degrees Celsius, 60 degrees Celsius, etc.), the CPU 20 determines that the canned drink D is in contact with the display 30 and displays the mark of the object that is in contact with the display 30 as the mark display 66.

In the eighth exemplary embodiment, a change that may occur in a bound book is reflected also in an electronic book. For example, in the case where the canned drink D is placed on a bound book, weight of the canned drink D may cause a dent in the bound book. In the eighth exemplary embodiment, such a change that may occur in a bound book is reflected also in an electronic book, by providing the mark display 66 as acquisition information.

In the eighth exemplary embodiment, the CPU 20 determines whether or not to provide the mark display 66 on the basis of object temperature. However, the CPU 20 may determine whether or not to provide the mark display 66 on the basis of other elements, in place of or in addition to object temperature. Examples of the other elements include the period of time of contact by an object, the shape and weight of the object, image information captured by the photographing unit 34, and the like.

### Ninth Exemplary Embodiment

Next, a ninth exemplary embodiment will be described. Description that overlaps with other exemplary embodiments will be omitted or simplified. Environmental information used in the ninth exemplary embodiment is information that may be acquired via the communication unit 36, specifically, weather information, which will be described layer, and image information captured by the photographing unit 34.

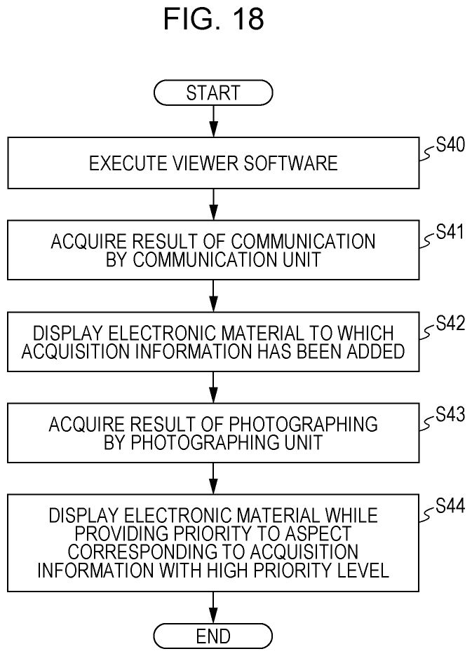

FIG. 18 is a flowchart illustrating a fourth flow of the electronic information display process performed by the information processing apparatus 10.

In step S40 in FIG. 18, the CPU 20 executes, using viewer software, a file in which electronic material created using document creation software is stored. Then, the process proceeds to step S41. In the ninth exemplary embodiment, for example, “electronic material” is used as electronic information, and “viewer software” is used as specific software.

In step S41, the CPU 20 acquires a result of communication by the communication unit 36. Then, the process proceeds to step S42. In the ninth exemplary embodiment, the CPU 20 acquires, as the result of communication by the communication unit 36, weather information within a range of five kilometers from a place where electronic material received from a weather server via the communication unit 36 is displayed.

In step S42, the CPU 20 displays electronic material to which acquisition information that matches the result of communication by the communication unit 36 has been added. Then, the process proceeds to step S43.

In step S43, the CPU 20 acquires a result of photographing by the photographing unit 34. Then, the process proceeds to step S44. In the ninth exemplary embodiment, in step S43, the CPU 20 executes image capturing software to perform, with the photographing unit 34, photographing around a place where a user is browsing electronic material. Then, the CPU 20 acquires, as the result of photographing by the photographing unit 34, image information captured by the photographing unit 34. The photographing unit 34 is an example of an “acquisition unit”, and a result of photographing is an example of a “result of acquisition”.

In step S44, the CPU 20 displays the electronic material while providing priority to an aspect corresponding to acquisition information whose predetermined priority level is high. Then, the CPU 20 ends the process.

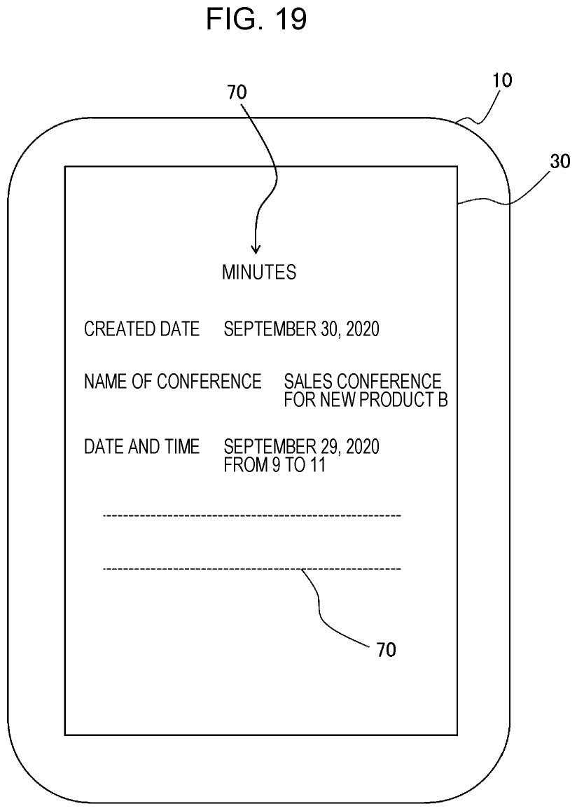

The display example of the electronic information display process illustrated in FIG. 18 will be described with reference to FIGS. 19 to 22.

FIG. 19 illustrates a display example of electronic material to which no acquisition information has been added. As illustrated in FIG. 19, on the display 30, a minutes display 70 indicating minutes created as electronic material using document creation software is displayed in its original aspect. In FIG. 19, the minutes display 70 includes characters “minutes” and broken lines, which are not characters.

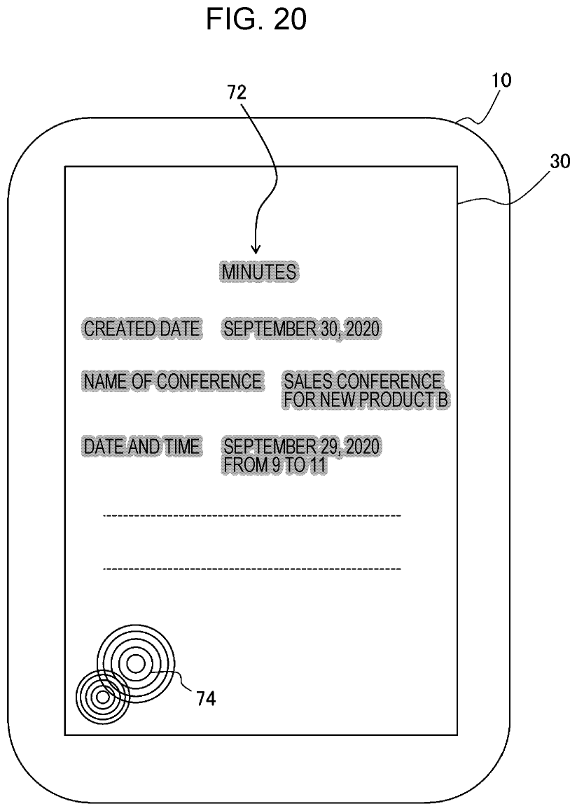

In the case where the processing of step S42 is performed while a user is browsing the display example illustrated in FIG. 19, the aspect of the electronic material is changed into that illustrated in FIG. 20.

FIG. 20 illustrates a fourth display example of electronic material to which acquisition information has been added. As illustrated in FIG. 20, on the display 30, a blur display 72 in which the characters of the minutes display 70 illustrated in FIG. 19 are displayed in a blurred manner and a raindrop display 74 are displayed as electronic material. In FIG. 20, as the blur display 72, a blur of characters is represented by coloring around the characters of the minutes display 70 illustrated in FIG. 19. The raindrop display 74, which includes a plurality of ripples, is displayed in a lower left part of the display 30. In the display example illustrated in FIG. 20, the blur display 72 and the raindrop display 74 are information added as acquisition information using the viewer software.

In the ninth exemplary embodiment, in the case where the weather information acquired in step S41 indicates rain, the CPU 20 displays the electronic material to which the blur display 72 and the raindrop display 74 have been added in step S42. Thus, in the ninth exemplary embodiment, it is expected that the user who browses the display example illustrated in FIG. 20 will be able to recognize that the weather around the place where the user is browsing the electronic material is rain.

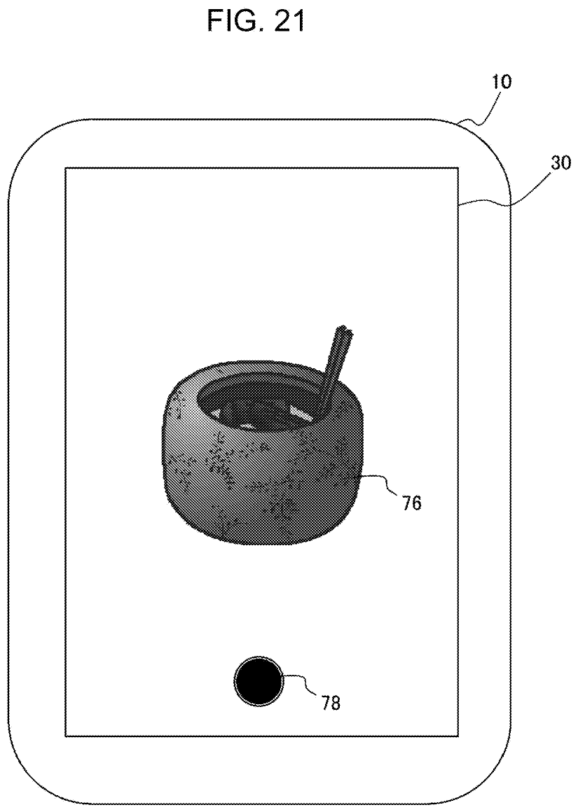

FIG. 21 illustrates a first display example of a state in which an image is being captured by the photographing unit 34. As illustrated in FIG. 21, on the display 30, an image 76 being captured and a shutter button 78 for capturing an image are displayed.

During capturing of an image by the photographing unit 34, the CPU 20 performs known image recognition processing for the image 76 being captured, so that the CPU 20 recognizes an object being photographed. For example, in the case illustrated in FIG. 21, as a result of image recognition processing, the CPU 20 recognizes an object being photographed as a “charcoal brazier”.

In the ninth exemplary embodiment, visual effects to be added as acquisition information to electronic material are stored in advance in the ROM 22 or the storing unit 26 in association with various objects. For example, as a visual effect corresponding to an object associated with “fire”, such as a charcoal brazier or a heater, information such as “dry and remove the provided raindrop display 74” is stored in the ROM 22 or the storing unit 26.

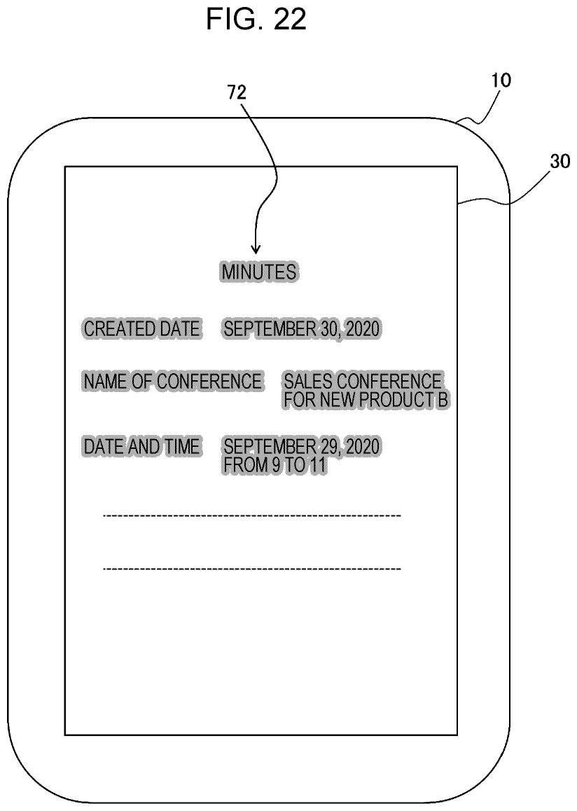

In the case where the processing of steps S43 and S44 is performed during browsing of the display example illustrated in FIG. 20, the aspect of the electronic material is changed to that illustrated in FIG. 22. For example, in the processing of step S43, the CPU 20 acquires, as a visual effect corresponding to “charcoal brazier”, which is an object acquired as a result of photographing by the photographing unit 34, information “dry and remove the provided raindrop display 74” from the ROM 22 or the storing unit 26. Then, in the processing of step S44, the CPU 20 displays the electronic material from which the provided raindrop display 74 has been deleted, while providing priority to an aspect corresponding to acquisition information with a high priority level. This will be described in detail below.

FIG. 22 illustrates a fifth display example of electronic material to which acquisition information has been added. As illustrated in FIG. 22, on the display 30, only the blur display 72 having the same content as that illustrated in FIG. 20 is displayed as electronic material. That is, in the display example illustrated in FIG. 22, the raindrop display 74 is not provided, unlike the display example illustrated in FIG. 20. Thus, in the display example illustrated in FIG. 22, by deleting the raindrop display 74 from the display example illustrated in FIG. 20, it is expected that a user will be given the impression that the wet material has dried.

As described above, in the ninth exemplary embodiment, when the CPU 20 acquires a plurality of results such as a result of communication by the communication unit 36 and a result of photographing by the photographing unit 34, the CPU 20 displays electronic material while providing priority to an aspect corresponding to a result with a high priority level out of the plurality of results. In the ninth exemplary embodiment, for example, the priority level of a result of photographing by the photographing unit 34 is higher than the priority level of a result of communication by the communication unit 36. Thus, in the ninth exemplary embodiment, in the case where the CPU 20 provides the raindrop display 74, which indicates raindrops associated with “water”, and then acquires, as a result of photographing by the photographing unit 34, the image 76 being captured, which indicates a charcoal brazier associated with “fire”, the CPU 20 displays the electronic material from which the raindrop display 74 has been deleted, by providing priority to an aspect corresponding to the result of photographing by the photographing unit 34 (see FIGS. 20 to 22).

In other words, in the ninth exemplary embodiment, it may also be said that the CPU 20 returns an aspect of electronic material to be displayed to an aspect before a change is made, by changing the aspect of the electronic material to be displayed in accordance with a result of communication by the communication unit 36 and then acquiring a result of photographing by the photographing unit 34, which has a higher priority level than that of the result of communication by the communication unit 36. Acquiring a result of photographing by the photographing unit 34 with a high priority level is an example of a state in which “a predetermined condition is satisfied”.

With the configuration described above, in the ninth exemplary embodiment, the aspect of electronic material to be displayed may be changed in accordance with a predetermined priority level in the case where the plurality of results are acquired. Furthermore, in the ninth exemplary embodiment, the number of aspects of electronic material to be displayed may be increased compared to the case where an aspect after the aspect of electronic material is changed is maintained.

In the ninth exemplary embodiment, even in the case where electronic material is displayed by providing priority to an aspect corresponding to a result of photographing by the photographing unit 34 with a high priority level, the blur display 72 having the same content is displayed in both FIGS. 20 and 22. As described above, in the ninth exemplary embodiment, there are a reversible change and an irreversible change. In a reversible change, return to an aspect before a change is made is possible in the case where a result of photographing by the photographing unit 34 with a high priority level is acquired. In an irreversible change, return to an aspect before a change is made is not possible even in the case where a result of photographing by the photographing unit 34 with a high priority level is acquired.

In the ninth exemplary embodiment, a change for displaying the raindrop display 74 illustrated in FIG. 20 made to the display example illustrated in FIG. 19 corresponds to a reversible change, and a change for displaying the blur display 72 illustrated in FIG. 20 from the minutes display 70 illustrated in FIG. 19 corresponds to an irreversible change. In the ninth exemplary embodiment, a change that may occur in paper material is reflected also in electronic material. Specifically, in the case where a blank part of paper material not including characters or images gets wet, when the wet dries, the paper material returns to its original aspect. Such a change is reflected also in electronic material as a reversible change as described above. Furthermore, in the case where a part of paper material including characters or images gets wet, even when the wet dries, the blurred characters or images do not return to its original aspect. Thus, such a change is reflected also in electronic material as an irreversible change as described above.

With the configuration described above, in the ninth exemplary embodiment, restriction may be imposed on return to an aspect of display of electronic material before a change is made.

In the ninth exemplary embodiment, a change that may occur in paper material is reflected also in electronic material. However, a change that is reflected also in electronic material is not limited to that described above. A change that may occur in paper material and is reflected also in electronic material may be set by a user. For example, in the ninth exemplary embodiment, a change from the minutes display 70 illustrated in FIG. 19 into the blur display 72 illustrated in FIG. 20 is defined as an irreversible change. However, the change from the minutes display 70 into the blur display 72 may be regarded as a reversible change by setting by a user.

In the ninth exemplary embodiment, the priority level of a result of photographing by the photographing unit 34 is higher than the priority level of a result of communication by the communication unit 36. However, a method for determining priority level is not limited to that described above. For example, the priority level of a result of communication by the communication unit 36 may be higher than the priority level of a result of photographing by the photographing unit 34, and the priority level of acquisition information associated with “water” may be higher than the priority level of acquisition information associated with fire. That is, in the ninth exemplary embodiment, in the case where a plurality of results such as a result of communication by the communication unit 36 and a result of photographing by the photographing unit 34 are acquired, the order in which changes occur, an aspect corresponding to one of the plurality of results to which priority is to be provided, and the like may be determined in an appropriate manner.

A change in an aspect of electronic material that matches a result of photographing by the photographing unit 34 described in the ninth exemplary embodiment is merely an example, and an aspect of electronic material to be displayed may be changed by using a result of photographing by the photographing unit 34 as described below.

For example, in the case where a moving image obtained by recording motion of a finger of a user is acquired as a result of photographing by the photographing unit 34, the CPU 20 may change the area, shape, and the like of acquisition information to be displayed, in accordance with the speed of the motion of the finger of the user. In this case, it is desirable that the degree to which electronic material to be displayed is changed increases as the speed of the motion of the finger of the user increases. Furthermore, in the case where a state in which a user holds an object (for example, a touch pen) and a state in which the user does not hold the object are acquired as results of photographing by the photographing unit 34, the CPU 20 may change the area, shape, and the like of acquisition information to be displayed, in accordance with the states. In this case, it is desirable that the degree to which electronic material to be displayed in the state in which the user holds an object (for example, a touch pen) is changed is higher than the degree to which electronic material to be displayed in the state in which the user does not hold the object is changed.

In the ninth exemplary embodiment, acquiring a result of photographing by the photographing unit 34 with a high priority level is an example of a state in which “a predetermined condition is satisfied”. However, an example of the state in which “a predetermined condition is satisfied” is not limited to that described above. For example, a state in which an aspect of electronic material to be displayed is changed in accordance with a result of communication by the communication unit 36, a result of photographing by the photographing unit 34, or the like and then a predetermined period of time has passed may be an example of the state in which “a predetermined condition is satisfied”, or a state in which a certain result is obtained and then another result that associates with an attribute, an operational effect, or the like that contradicts the certain result, such as a case where a result of communication by the communication unit 36 associated with “water” is acquired and a result of photographing by the photographing unit 34 associated with “fire” is then acquired, may be an example of the state in which “a predetermined condition is satisfied”.

### Tenth Exemplary Embodiment

Next, a tenth exemplary embodiment will be described. Description that overlaps with other exemplary embodiments will be omitted or simplified.

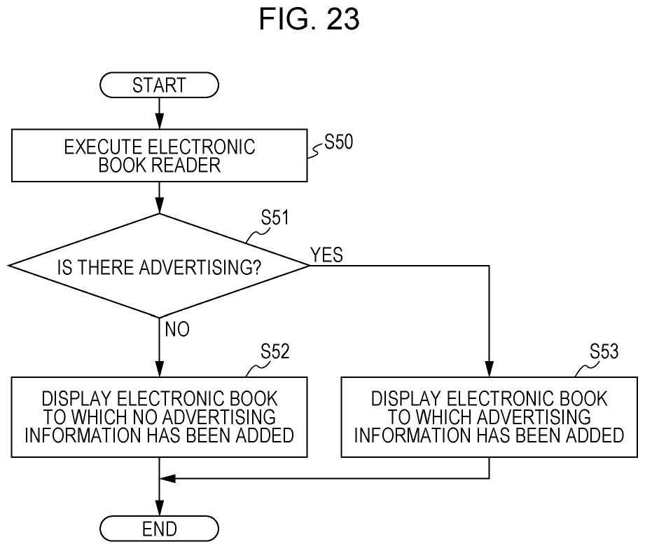

FIG. 23 is a flowchart illustrating a fifth flow of the electronic information display process performed by the information processing apparatus 10.

In step S50 illustrated in FIG. 23, the CPU 20 executes, using an electronic book reader, a file in which an electronic book distributed from a content distribution server is stored. Then, the process proceeds to step S51. In the tenth exemplary embodiment, for example, an “electronic book” is used as electronic information, and an “electronic book reader” is used as specific software.

In step S51, the CPU 20 determines whether or not there is advertising as environmental information regarding an electronic book. In the case where the CPU 20 determines that there is no advertising (step S51: NO), the process proceeds to step S52. In contrast, in the case where the CPU 20 determines that there is advertising (step S51: Yes), the CPU 20 proceeds to step S53. In the tenth exemplary embodiment, the CPU 20 acquires, as a result of communication by the communication unit 36, presence or absence of advertising as environmental information regarding the electronic book from the distributor server for the electronic book via the communication unit 36. In this case, in the case where there is no advertising provided from the distribution server, the CPU 20 determines that “there is no advertising”. In the case where there is advertising provided from the distributor server, the CPU 20 determines that “there is advertising.”

In step S52, the CPU 20 displays the electronic book to which no advertising information has been added. Then, the CPU 20 ends the process. In this case, the CPU 20 displays on the display 30 the same content as that illustrated in FIG. 12, which is a display example of an electronic book to which no acquisition information has been added in the sixth exemplary embodiment.

In step S53, the CPU 20 displays the electronic book to which advertising information has been added. Then, the CPU 20 ends the process.

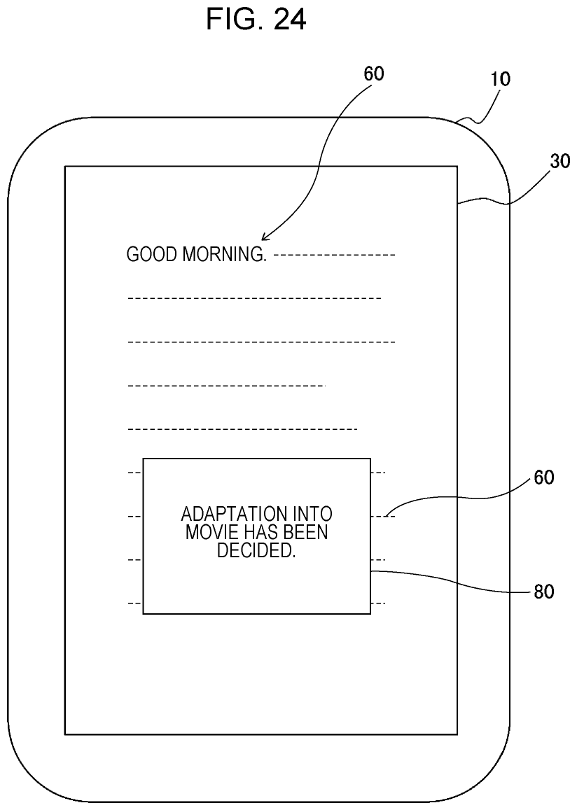

FIG. 24 illustrates a display example of an electronic book to which advertising information has been added. As illustrated in FIG. 24, on the display 30, the text display 60 having the same content as that illustrated in FIG. 12 and an advertising display 80 are displayed as an electronic book. The advertising display 80 having a rectangular frame containing characters “Adaptation into movie has been decided.” is provided in a central part of the display 30. In the display example illustrated in FIG. 24, the text display 60 is information distributed from the content distribution server, and the advertising display 80 is information added as advertising information using the electronic book reader.

In the tenth exemplary embodiment, because the CPU 20 performs control such that the advertising display 80 is preferentially displayed in an overlap part in which the text display 60 and the advertising display 80 overlap, only the advertising display 80 is visible in the overlap part. The CPU 20 deletes the advertising display 80 from the display 30 after a predetermined time has passed.

As described above, in the tenth exemplary embodiment, the CPU 20 acquires presence or absence of advertising as environmental information regarding an electronic book. In the case where there is advertising, the CPU 20 displays the electronic book to which advertising information corresponding to the advertising has been added. Thus, in the tenth exemplary embodiment, the number of aspects of an electronic book to be displayed may be increased compared to a configuration in which only text of an electronic book is displayed.

In the tenth exemplary embodiment, a change that may occur in a bound book is reflected also in an electronic book. For example, a strip of paper in which content that changes every certain period is described may be provided around a bound book. In the tenth exemplary embodiment, such a change that may occur in a bound book is reflected also in an electronic book, by adding the advertising display 80 as advertising information.

In the tenth exemplary embodiment, the CPU 20 determines whether or not there is advertising display 80 on the basis of presence or absence of advertising provided from the distributor server. However, the CPU 20 may determine whether or not there is advertising display 80 on the basis of other elements, in place of or in addition to presence or absence of advertising provided from the distributor server. For example, website crawling may be performed, so that the CPU 20 may determine whether or not there is the advertising display 80 on the basis of the result of the website crawling.

In the tenth exemplary embodiment, content “Adaptation into movie has been decided.” is displayed as the advertising display 80 as advertising information (see FIG. 24). However, the display content of the advertising display 80 is not limited to that described above. For example, in the case where advertising as environmental information regarding an electronic book is about a new published book by an author of the electronic book, “New book has been published.” may be provided as the display content of the advertising display 80. In the case where advertising is about selling of a character merchandise of a character appearing in the electronic book, “Character merchandises are available.” may be provided as the display content of the advertising display 80. Furthermore, in the case where an advertising page corresponding to the advertising display 80 may be accessible from the advertising display 80 and a user has accessed the advertising page from the advertising display 80, the advertising display 80 may be deleted. This is because the purpose of the advertising has been achieved by access to the advertising page by the user and there is less meaning to keep displaying the advertising display 80. Moreover, keeping displaying the advertising display 80 after the purpose of advertising has been achieved may cause a user to feel uncomfortable.

In the tenth exemplary embodiment, the advertising display 80 has been described as advertising information. However, warning information, notice information, or the like may be displayed additionally. For example, in the case where the expiration term for display of an electronic book is approaching, a display for requiring additional charge is assumed to be displayed as notice information. Furthermore, advertising information may be used as notification of additional information by update of specific software for displaying an electronic book, notification indicating that a bug may be corrected, or the like.

### Eleventh Exemplary Embodiment

Next, an eleventh exemplary embodiment will be described. Description that overlaps with other exemplary embodiments will be omitted or simplified.

The eleventh exemplary embodiment is different from the exemplary embodiments described in that a screen of the display 30 displayed in the case where an electronic book reader is executed is a list screen indicating the list of electronic books, in place of a text screen indicating text of an electronic book.

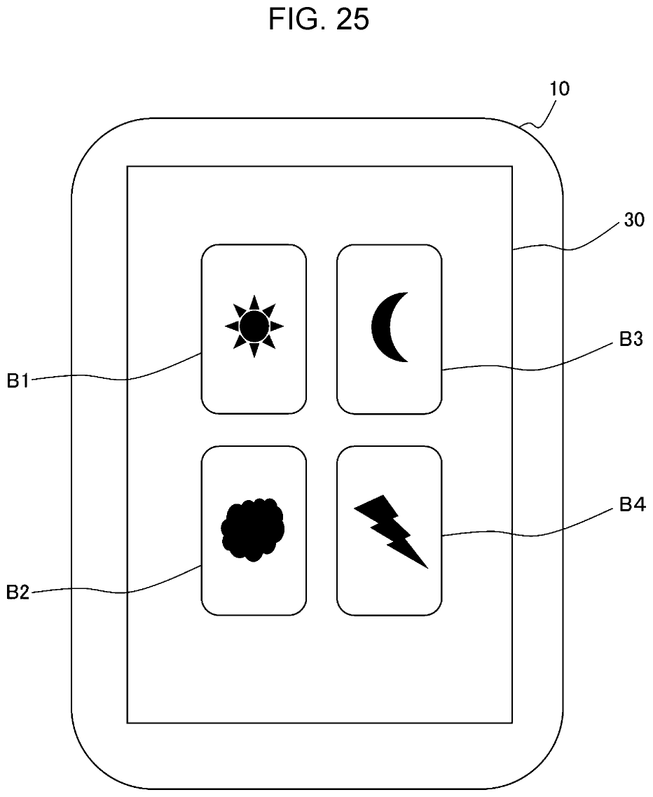

FIG. 25 illustrates a first display example of a list screen indicating the list of electronic books. As illustrated in FIG. 25, on the display 30, a book display B1, a book display B2, a book display B3, and a book display B4 indicating four electronic books that are able to be browsed are displayed. Furthermore, in the book displays B1 to B4, front cover pages corresponding to front covers of the book displays B1 to B4 are displayed.

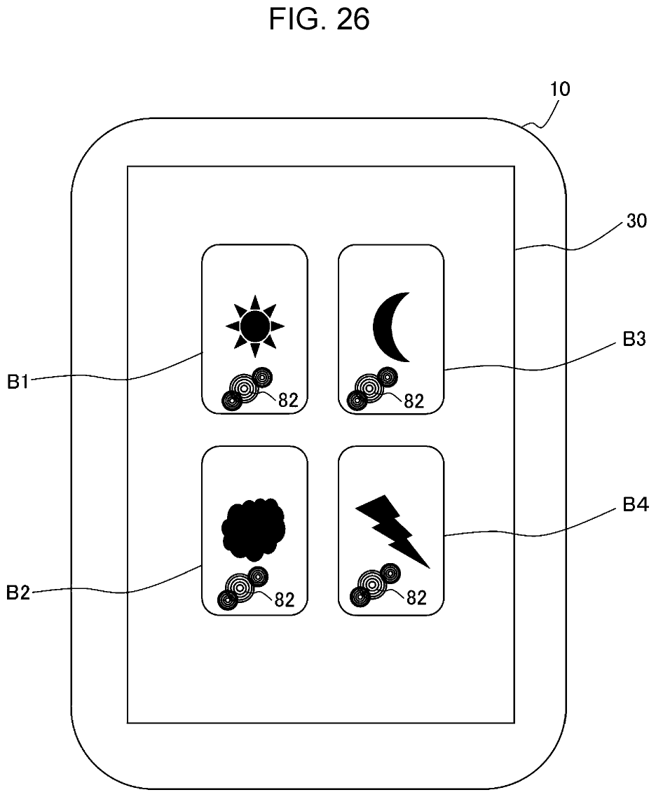

FIG. 26 illustrates a second display example of the list screen indicating the list of electronic books. As illustrated in FIG. 26, on the display 30, the book display B1, the book display B2, the book display B3, and the book display B4 having the same content as those illustrated in FIG. 25 and raindrop displays 82 are displayed. The raindrop displays 82 each including a plurality of ripples are displayed in lower left parts of the corresponding front cover pages. In the display example illustrated in FIG. 26, the book display B1, the book display B2, the book display B3, and the book display B4 are information distributed from a content distribution server, and the raindrop displays 82 are information added as acquisition information using the electronic book reader.

In an exemplary embodiment described above, in the case where the CPU 20 displays electronic information to which acquisition information has been added, the acquisition information is displayed in all the pages of the electronic information. In contrast, in the eleventh exemplary embodiment, the raindrop display 82 is provided as acquisition information only in a front cover page, and the raindrop display 82 is not provided in pages in which text of an electronic book is displayed following the front cover page.

In the eleventh exemplary embodiment, the raindrop display 82 as acquisition information is provided only in a front cover page. However, a page in which the raindrop display 82 as acquisition information is provided is not necessarily limited to the front cover page. The raindrop display 82 may be provided also in pages in which text of an electronic book is displayed following the front cover page under a certain condition. For example, in the case where weather information acquired as a result of communication by the communication unit 36 indicates rain and the amount of rain per unit time (for example, one hour) is more than a predetermined amount (for example, 50 mm), the raindrop display 82 may be provided also in pages in which text of an electronic book is displayed following the front cover page. As a method for providing the raindrop display 82 in this case, it is assumed that the raindrop display 82 is provided in the front cover page and then provided in an end part of the next page. That is, by causing a change that may occur in a bound book to be reflected also in an electronic book, the state in which the wet of the front cover page soaks into the following pages may be represented.

### Twelfth Exemplary Embodiment

Next, a twelfth exemplary embodiment will be described. Description that overlaps with other exemplary embodiments will be omitted or simplified.

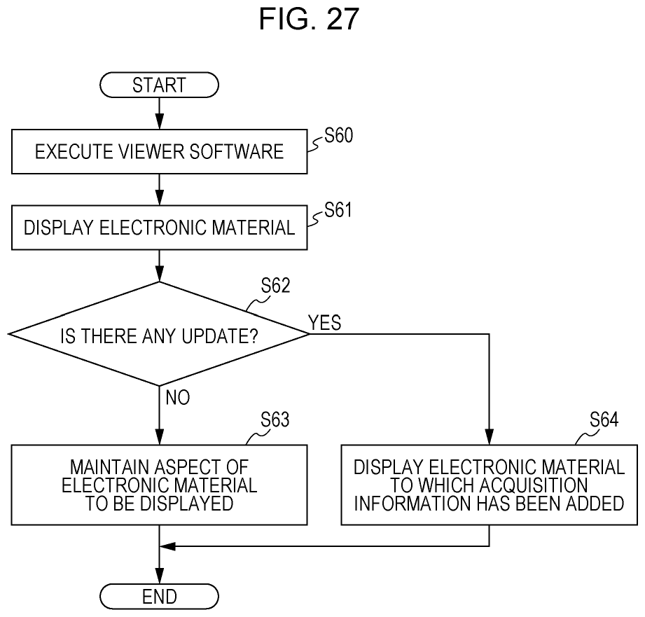

FIG. 27 is a flowchart illustrating a sixth flow of the electronic information display process performed by the information processing apparatus 10.

In step S60 illustrated in FIG. 27, the CPU 20 executes, using viewer software, a file in which electronic material distributed from a data distribution server is stored. Then, the process proceeds to step S61. In the twelfth exemplary embodiment, for example, “electronic material” is used as electronic information, and “viewer software” is used as specific software.

In step S61, the CPU 20 displays electronic material distributed from the data distribution server. Then, the process proceeds to step S62.

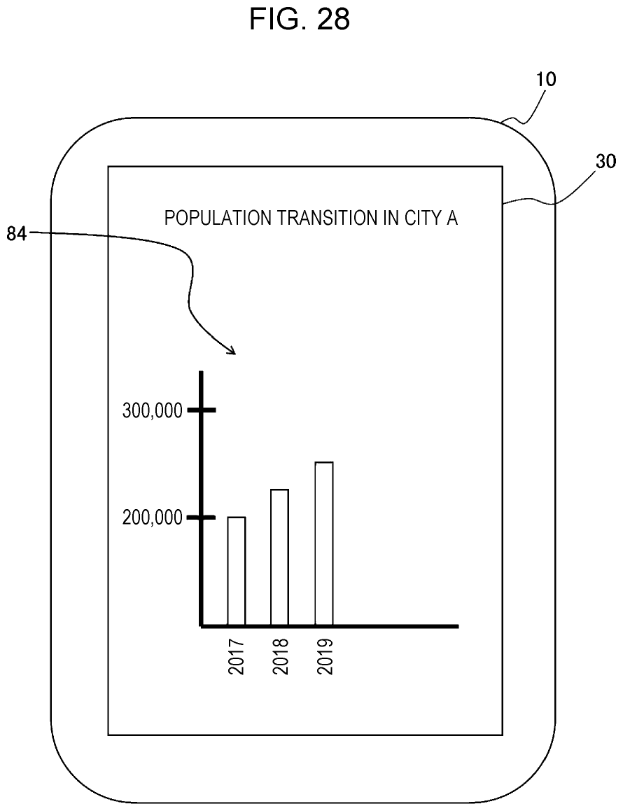

FIG. 28 illustrates a display example of electronic material distributed from the data distribution server. As illustrated in FIG. 28, on the display 30, a graph 84 indicating population transition in City A is displayed as electronic material. In the graph 84 illustrated in FIG. 28, population transition in City A for three years 2017, 2018, and 2019 is indicated.

Referring back to FIG. 27, in step S62, the CPU 20 determines whether or not there is any update in the electronic material illustrated in FIG. 28. In the case where the CPU 20 determines that there is no update (step S62: No), the process proceeds to step S63. In contrast, in the case where the CPU 20 determines that there is an update (step S62: Yes), the process proceeds to step S64. In the twelfth exemplary embodiment, the CPU 20 acquires, as a result of communication by the communication unit 36, presence or absence of update regarding the electronic material from the data distribution server (for example, a server managed by A City Government) via the communication unit 36. In this case, in the case where no update data is provided from the data distribution server, the CPU 20 determines that “there is no update”. In the case where update data is provided from the data distribution server, the CPU 20 determines that “there is an update”.

In step S63, the CPU 20 maintains the aspect of the electronic material displayed in step S61. Then, the CPU 20 ends the process.

In step S64, the CPU 20 displays the electronic material to which acquisition information has been added. Then, the CPU 20 ends the process.

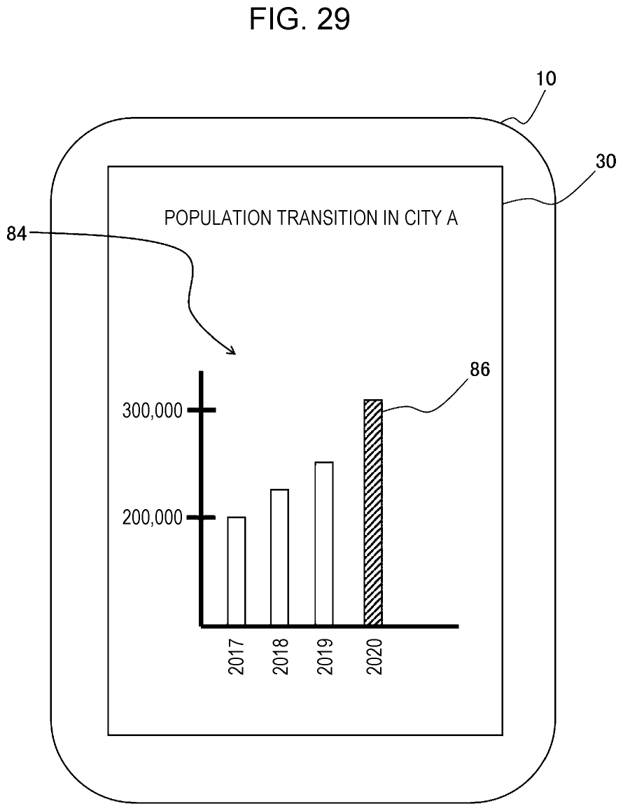

FIG. 29 illustrates a sixth display example of electronic material to which acquisition information has been added. As illustrated in FIG. 29, on the display 30, the graph 84 is displayed as electronic material as in FIG. 28, and population transition in City A in year 2020 has been added as an update display 86. In the display example illustrated in FIG. 29, oblique lines are provided in a bar graph corresponding to the update display 86 so that visibility is increased compared to bar graphs for other years. The update display 86 in the graph 84 provided on the display 30 may be represented by oblique lines or the like or an aspect of the bar graph corresponding to the update display 86 may be the same as aspects of bar graphs for other years, without oblique lines or the like being provided.

In the display example illustrated in FIG. 29, in the graph 84, bar graphs indicating population transition in City A for three years from 2017 to 2019 are information distributed from the data distribution server, and the update display 86 is information added as acquisition information using the viewer software. Specifically, in the twelfth exemplary embodiment, the CPU 20 acquires the value of population transition in City A for year 2020 as update data from the data distribution server. Then, the CPU 20 creates a bar graph indicating the population transition in City A for year 2020 using the viewer software on the basis of the acquired value, and displays the generated bar graph as the update display 86.

In the twelfth exemplary embodiment, it is desirable that the update display 86 is not able to be displayed until update data is provided from the data distribution server. In other words, in the twelfth exemplary embodiment, it is desirable that a bar graph is not able to be added at a timing desired by a user before public information is released.

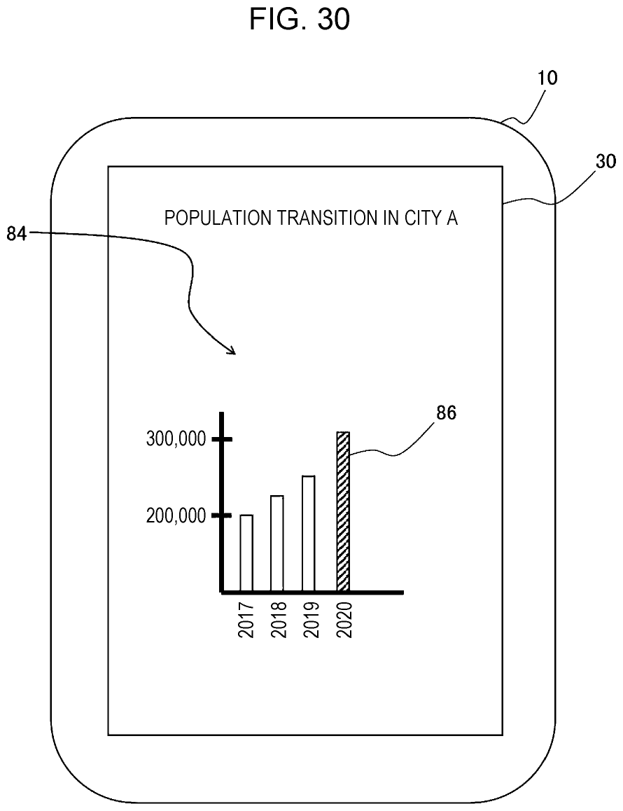

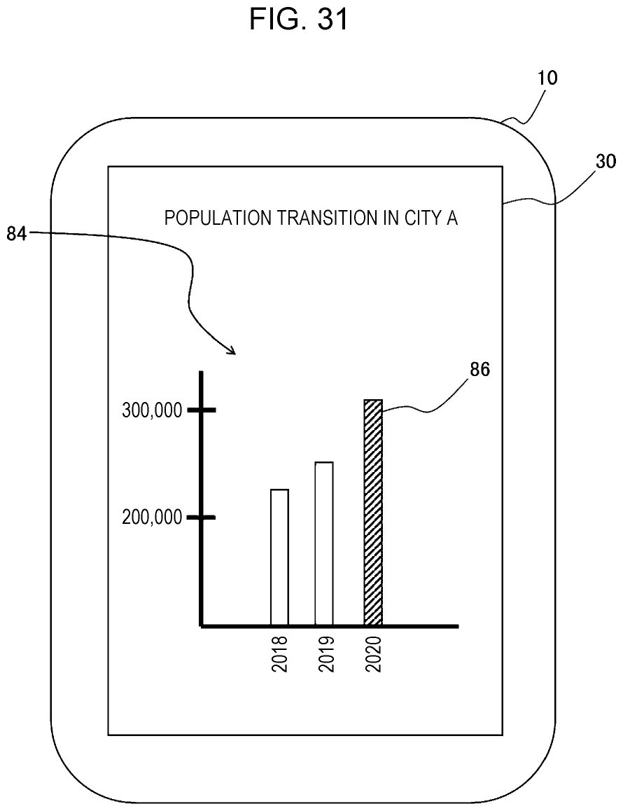

In the case where the CPU 20 displays the electronic material to which the acquisition information has been added in step S64, the size of the graph 84 to be displayed may be reduced compared to the size displayed in step S61, as illustrated in FIG. 30. Furthermore, in the case where the CPU 20 displays electronic material to which the acquisition information has been added in step S64, the CPU 20 may delete a bar graph indicating population transition in City A for part of years displayed in step S61 (for example, 2017), as illustrated in FIG. 31.

Furthermore, although illustration is omitted, in the case where the CPU 20 displays the electronic material to which the acquisition information has been added in step S64, the size of the graph 84 to be displayed may be increased compared to the size displayed in step S61. If the display region of the graph 84 in a page of the electronic material displayed in step S61 becomes insufficient by the increase in the size, the CPU 20 may display the enlarged graph 84 in the next page.

### Thirteenth Exemplary Embodiment

Next, a thirteenth exemplary embodiment will be described. Description that overlaps with other exemplary embodiments will be omitted or simplified.

In the thirteenth exemplary embodiment, a change in an aspect of electronic information occurring in a state in which specific software is executed to create material or the like or capture an image, unlike an exemplary embodiment described above in which a file created or photographed in advance is executed using specific software, will be described. In the thirteenth exemplary embodiment, for example, “image information” is used as electronic information, and “image capturing software” is used as specific software.

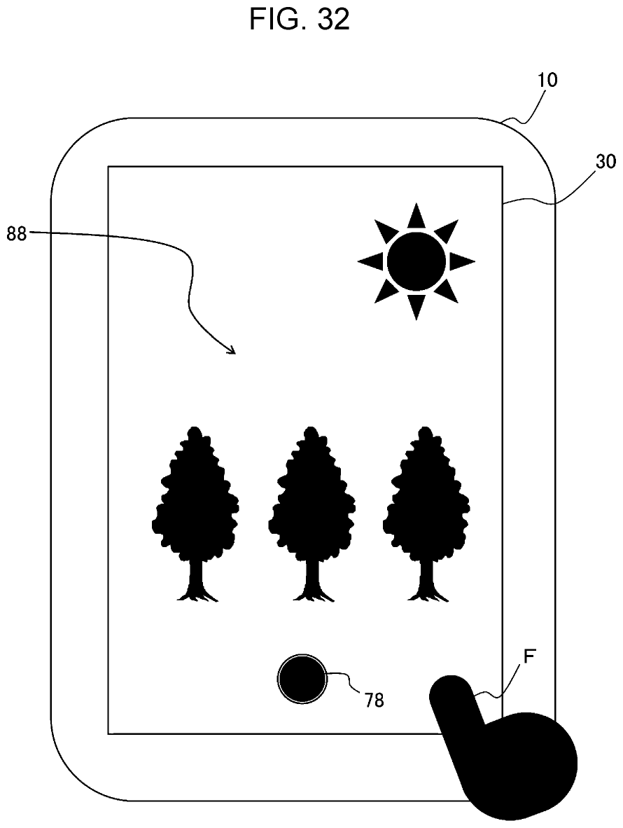

FIG. 32 illustrates a second display example of a state in which an image is being captured by the photographing unit 34. As illustrated in FIG. 32, on the display 30, an image 88 being captured and the shutter button 78 for capturing an image are displayed as image information in their original aspects. In FIG. 32, the finger display F schematically indicating a finger of a user is illustrated.

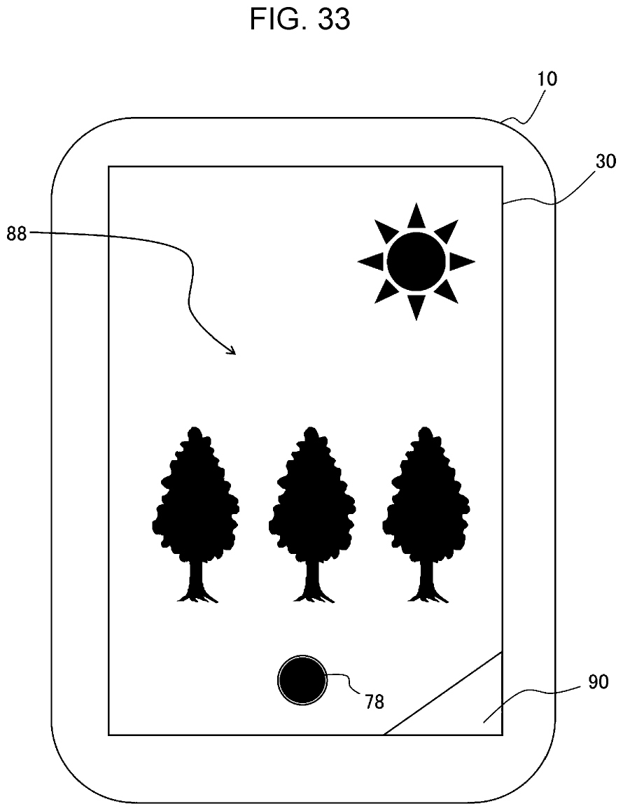

FIG. 33 illustrates a third display example of a state in which an image is being captured by the photographing unit 34. As illustrated in FIG. 33, on the display 30, the image 88 being captured having the same content as that illustrated in FIG. 32, the shutter button 78, and a tear display 90 are displayed as image information. The tear display 90, which has a triangular shape, is displayed in a lower right part of the display 30. In the display example illustrated in FIG. 33, the tear display 90 is information added as acquisition information using the image capturing software.

The tear display 90 is displayed when contact on the display 30 from the outside is detected by the detection unit 32. For example, in the display example illustrated in FIG. 33, contact is detected by the detection unit 32 when a finger of a user is in contact with a lower right part of the display 30 in the state of the display example illustrated in FIG. 32, and the CPU 20 displays image information to which the tear display 90 that matches the result of detection by the detection unit 32 has been added.

In the thirteenth exemplary embodiment, the tear display 90 is provided as acquisition information on image information, so that part of the image information that corresponds to the part in which the tear display 90 is displayed is invisible, as in an exemplary embodiment described above. However, part of image information is not necessarily made invisible by providing the tear display 90. Part of image information may be deleted as provision of acquisition information, so that part of the image information that corresponds to the part in which the image information is deleted may be made invisible.

In the thirteenth exemplary embodiment, an example of the case where “image capturing software” is used as specific software has been described. However, specific software is not limited to the “image capturing software”. For example, “document creation software”, “spreadsheet software”, or “presentation software” different from the “viewer software” and the “electronic book reader” that execute a file created or photographed in advance as in an exemplary embodiment described above may be used as specific software in the thirteenth exemplary embodiment.

### Fourteenth Exemplary Embodiment

Next, a fourteenth exemplary embodiment will be described. Description that overlaps with other exemplary embodiments will be omitted or simplified.

In the fourteenth exemplary embodiment, when executing specific software to display electronic information, the CPU 20 displays the electronic information to which acquisition information that matches a result of detection by the detection unit 32 has been added, as in the sixth exemplary embodiment. Environmental information used in the fourteenth exemplary embodiment is presence or absence of contact on the display 30 from the outside, which will be described below, as in the sixth exemplary embodiment.

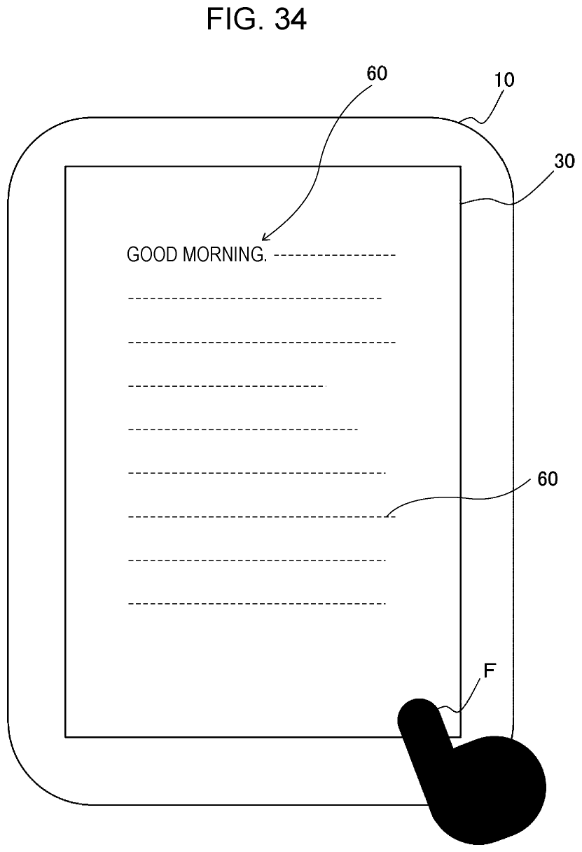

FIG. 34 illustrates a display example of an end position at which detection of contact on the display 30 by the detection unit 32 ends. As illustrated in FIG. 34, on the display 30, the text display 60 having the same content as that illustrated in FIG. 12 is provided as an electronic book in its original aspect. Furthermore, in the fourteenth exemplary embodiment, the position of the finger display F in FIG. 34 corresponds to the end position mentioned above, and the position of the finger display F in FIG. 12 corresponds to an initial position at which contact on the display 30 is first detected by the detection unit 32.

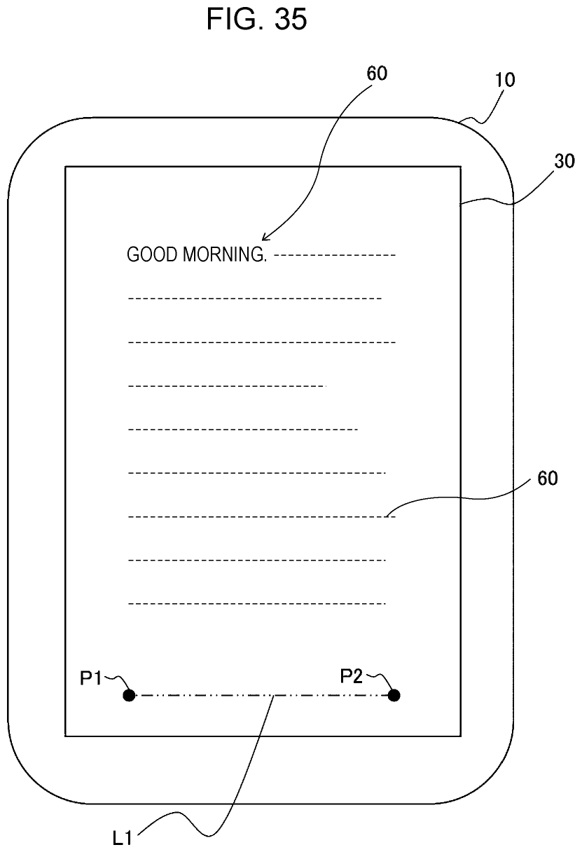

FIG. 35 illustrates a display example of a locus L1 of the position of contact on the display 30 detected by the detection unit 32. In FIG. 35, a locus L1 starting from an initial position P1 to an end position P2 is illustrated. The locus L1 is a locus of a straight line extending from the initial position P1 toward a right part of the display 30.

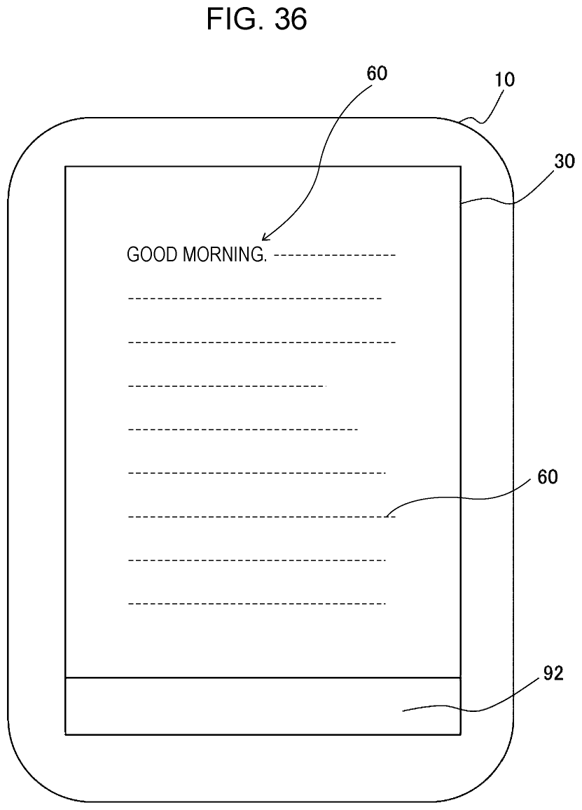

FIG. 36 illustrates a fourth display example of an electronic book to which acquisition information has been added. As illustrated in FIG. 36, on the display 30, the text display 60 having the same content as that illustrated in FIGS. 34 and 35 and a tear display 92 are provided as an electronic book. The tear display 92, which has a rectangular shape, is provided in a lower part of the display 30. In the display example illustrated in FIG. 36, the text display 60 is information distributed from the content distribution server, and the tear display 92 is information added as acquisition information using the electronic book reader.

The tear display 92 is provided when contact on the display 30 from the outside is detected by the detection unit 32. For example, in the display example illustrated in FIG. 36, contact by a finger of a user forming the locus L1 illustrated in FIG. 35 is detected by the detection unit 32, and the CPU 20 displays an electronic book to which the tear display 92 that matches the result of the detection by the detection unit 32 has been added. In this case, the CPU 20 provides, as the result of the detection by the detection unit 32, a tear display with a shape that matches a direction of force applied to the display 30. For example, in the display example illustrated in FIG. 36, provision of the tear display 92 having a rectangular shape indicates that the electronic book has been torn into a shape that matches a swipe operation by the user.

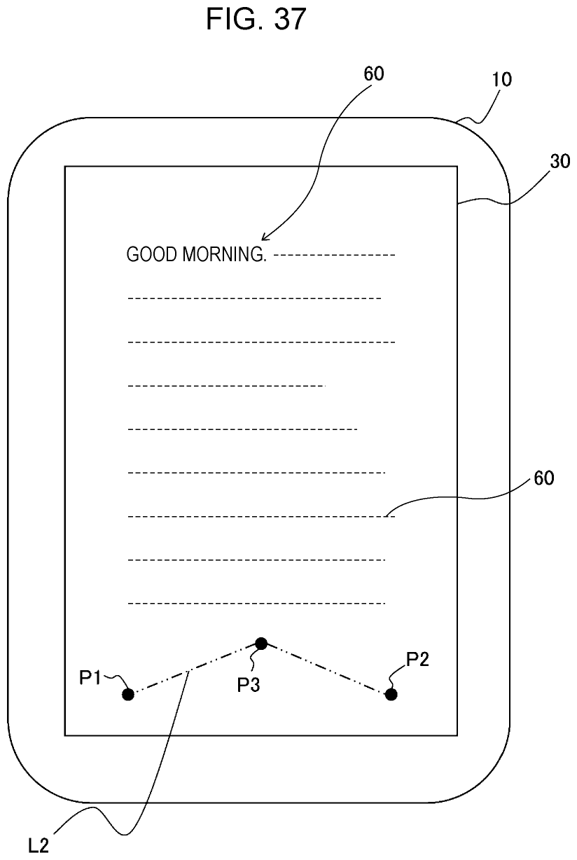

FIG. 37 illustrates a display example of a locus L2 of the position of contact on the display 30 detected by the detection unit 32. In FIG. 37, the locus L2 starting from the initial position P1, passing through a half-way point P3, and ending at the end position P2 is illustrated. The locus L2 is a locus of a bent line extending in a straight line from the initial position P1 toward an upper right part of the display 30 up to the half-way point P3 and then extending in a straight line toward a lower right part of the display 30 up to the end position P2.

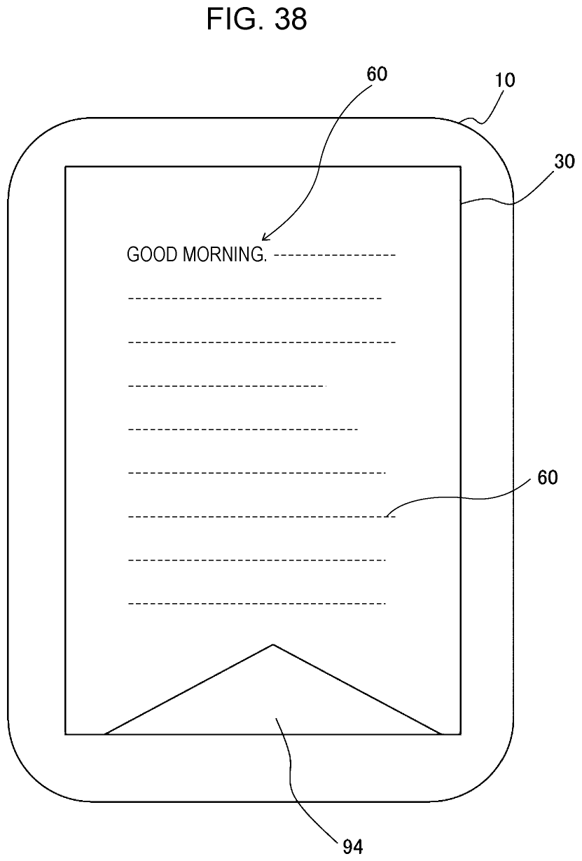

FIG. 38 illustrates a fifth display example of an electronic book to which acquisition information has been added. As illustrated in FIG. 38, on the display 30, the text display 60 having the same content as that illustrated in FIG. 36 and a tear display 94 are displayed as an electronic book. The tear display 94, which has a triangular shape, is displayed in a lower part of the display 30. In the display example illustrated in FIG. 38, the text display 60 is information distributed from the content distribution server, and the tear display 94 is information added as acquisition information using the electronic book reader.

The tear display 94 is provided when contact on the display 30 from the outside is detected by the detection unit 32. For example, in the display example illustrated in FIG. 38, contact by a finger of a user forming the locus L2 illustrated in FIG. 37 is detected by the detection unit 32, and the CPU 20 displays an electronic book to which the tear display 94 that matches the result of the detection by the detection unit 32 has been added. In this case, the CPU 20 provides, as the result of the detection by the detection unit 32, a tear display with a shape that matches a direction of force applied to the display 30, as described above. For example, in the display example illustrated in FIG. 38, provision of the tear display 94 having a triangular shape indicates that the electronic book has been torn into a shape that matches a swipe operation by the user.

As described above, in the fourteenth exemplary embodiment, in the case where contact on the display 30 is detected by the detection unit 32 as generation of environmental information on the display 30, the CPU 20 changes the degree to which an aspect of an electronic book to be displayed is changed from an aspect before acquisition information is added, in accordance with a locus starting from an initial position to an end position at which contact on the display 30 is detected by the detection unit 32. For example, in the fourteenth exemplary embodiment, even in the case where the initial position and the end position of contact on the display 30 are the same between loci, if the loci pass through different half-way points, aspects of tear displays to be provided are different. Thus, in the fourteenth exemplary embodiment, the degree to which an aspect of an electronic book to be displayed is changed from an aspect before acquisition information is added may be changed in accordance with a locus starting from an initial position to an end position at which contact on the display 30 is detected by the detection unit 32.

In the fourteenth exemplary embodiment, the shape of a tear display to be provided is changed in accordance with the direction of force applied to the display 30. However, in place of or in addition to the shape of the tear display to be provided, other elements such as the area of the tear display to be provided may be changed.

### (Others)

In an exemplary embodiment described above, electronic information includes one of a document and an image. However, the electronic information may include at least one of a document and an image or both a document and an image.

In an exemplary embodiment described above, electronic information is displayed in an aspect that matches one of a use state of the electronic information and environmental information. However, electronic information may be displayed in an aspect that matches at least one of the use state of the electronic information and environmental information or may be displayed in an aspect that matches both the use state of the electronic information and environmental information.

In an exemplary embodiment described above, in the case where weather information is acquired as the result of communication by the communication unit 36 and an aspect of display of electronic information is changed in accordance with information of temperature included in the weather information, the aspect of display of the electronic information may be returned to an aspect before the change is made when a predetermined time has passed.

In an exemplary embodiment described above, in the case where electronic information is displayed in an aspect that matches at least one of the use state of the electronic information and environmental information, a plurality of types of data, that is, data before the aspect of the electronic information is changed and data after the aspect of the electronic information is changed, may be stored in the storing unit 26 or only the data after the aspect of the electronic information is changed may be stored in the storing unit 26. In this case, in the case where an “electronic book” is used as electronic information, it is desirable that a content distributor that distributes the electronic book has an authority to determine whether one type or a plurality of types of data are to be stored. This is because, for example, by storing only data after the aspect of the electronic book is changed, it is expected that a user who wishes to browse the aspect before the change is made will purchase the electronic book again. Furthermore, in the case where a changed aspect of electronic information is stored in the storing unit 26, the aspect of the electronic information may be maintained or returned to an aspect before the change is made, in accordance with the timing at which a user browses the electronic information again. For example, in the case where electronic information to which the raindrop display (see FIG. 7) has been added as acquisition information is stored in the storing unit 26, if a user browses the electronic information again after a predetermined time or more has passed (for example, one week), the electronic information to which the raindrop display 52 is not added may be displayed.

In an exemplary embodiment described above, the degree of change for display of electronic information may be changed in an aspect that matches at least one of the use state of the electronic information and environmental information, in accordance with the page of the electronic information being displayed. For example, the degree of change for display of electronic information may be changed between a front cover page and a page in which text of the electronic information is displayed following the front cover page.

In an exemplary embodiment, in the case where an “electronic book” is used as electronic information and content of the electronic book is also available as a bound book, the degree of change for display of an electronic book may be changed in an aspect that matches at least one of the use state of the electronic book and environmental information, in accordance with the paper quality of the bound book. For example, it is assumed that, in the case where the front cover of the bound book is a hard cover, the area of the raindrop display 82 (see FIG. 26) to be displayed in the front cover page of the electronic book is larger than that in the case where the front cover is a soft cover. Furthermore, information of the paper quality of a bound book may be input to the information processing apparatus 10 by a user or the CPU 20 may acquire information that is open to the public through networks via the communication unit 36.

In an exemplary embodiment described above, the information processing apparatus 10 is, for example, a portable terminal such as a smartphone, a tablet terminal, or portable notebook personal computer (PC). However, the information processing apparatus 10 may be a portable terminal including a flexible display or a so-called “dual-screen smartphone” including multiple displays. In the case where the information processing apparatus 10 is a portable terminal including a flexible display or a so-called “dual-screen smartphone”, the detection unit 32 may detect bending, twisting, opening and closing, or the like of the information processing apparatus 10.

In an exemplary embodiment described above, the CPU 20 displays electronic information on the display 30 of the information processing apparatus 10. However, electronic information is not necessarily displayed on the display 30. For example, the CPU 20 may display electronic information on a display screen of another apparatus different from the information processing apparatus 10 or may display electronic information in space so that an aerial display may be configured.

In an exemplary embodiment described above, an example in which electronic information is stored in the storing unit 26 of the information processing apparatus 10 has been described. However, electronic information is not necessarily stored in the storing unit 26 of the information processing apparatus 10. Electronic information may be recorded in a storing unit of an external apparatus. In this case, the electronic information recorded in the storing unit of the external apparatus may be accessed using a communication technique such as the Internet. Alternatively, an external storage memory device may be temporarily connected physically to the information processing apparatus 10, so that electronic information may be read and displayed at the information processing apparatus 10. Furthermore, in the case where electronic information recorded in a storing unit or the like of an external apparatus is shared among multiple users and displayed, an aspect of display of the electronic information may be changed according to situations of the multiple users or the uniform aspect of display may be provided for the same electronic information. For example, it is assumed that user authentication is used as means for identifying a user from among multiple users. By recognizing a user account for specific software for displaying corresponding electronic information as a result of user authentication, an aspect of display of the electronic information may be changed according to the user. Obviously, there may be users for whom an aspect of display is not changed. In a situation in which the same electronic information is edited collaboratively at the same time or the same electronic information is browsed and read at the same time, a principal user account may be set out of multiple user accounts, and the aspect of display of the electronic information may be changed according to the situation of a user of the principal user account.

Content described in the exemplary embodiments and (others) described above may be combined in an appropriate manner.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
when executing software that is capable of displaying electronic information including at least one of a document and an image so that the electronic information is displayed, display the electronic information in an aspect that matches at least one of a use state of the electronic information and environmental information indicating environment around a place where the electronic information is displayed.

2. The information processing apparatus according to claim 1,
wherein the use state of the electronic information includes at least one of the number of browsing times that the electronic information has been browsed, the number of transfer times that the electronic information has been transferred, and the number of duplication times that the electronic information has been duplicated, and
wherein the processor is configured to, in a case where the use state of the electronic information exceeds a predetermined threshold, display the electronic information to which predetermined additional information has been added.

3. The information processing apparatus according to claim 2,
wherein the predetermined threshold includes a plurality of levels of thresholds, and
wherein the processor is configured to, as the level of the threshold exceeded increases, increase a degree to which the aspect of the electronic information to be displayed is changed from an aspect before the additional information is added.

4. The information processing apparatus according to claim 1,
wherein the processor is configured to display the electronic information to which acquisition information has been added, the acquisition information matching a result of acquisition by an acquisition unit that acquires at least one of the use state of the electronic information and the environmental information.

5. The information processing apparatus according to claim 2,
wherein the processor is configured to display the electronic information to which acquisition information has been added, the acquisition information matching a result of acquisition by an acquisition unit that acquires at least one of the use state of the electronic information and the environmental information.

6. The information processing apparatus according to claim 3,
wherein the processor is configured to display the electronic information to which acquisition information has been added, the acquisition information matching a result of acquisition by an acquisition unit that acquires at least one of the use state of the electronic information and the environmental information.

7. The information processing apparatus according to claim 4, wherein the processor is configured to, by adding the acquisition information, change an aspect of the entire electronic information to be displayed from an aspect before the acquisition information is added.

8. The information processing apparatus according to claim 5, wherein the processor is configured to, by adding the acquisition information, change an aspect of the entire electronic information to be displayed from an aspect before the acquisition information is added.

9. The information processing apparatus according to claim 6, wherein the processor is configured to, by adding the acquisition information, change an aspect of the entire electronic information to be displayed from an aspect before the acquisition information is added.

10. The information processing apparatus according to claim 4, wherein the processor is configured to, by adding the acquisition information, change an aspect of part of the electronic information to be displayed from an aspect before the acquisition information is added.

11. The information processing apparatus according to claim 5, wherein the processor is configured to, by adding the acquisition information, change an aspect of part of the electronic information to be displayed from an aspect before the acquisition information is added.

12. The information processing apparatus according to claim 6, wherein the processor is configured to, by adding the acquisition information, change an aspect of part of the electronic information to be displayed from an aspect before the acquisition information is added.

13. The information processing apparatus according to claim 10, wherein the processor is configured to, when the environmental information is generated on a display for displaying the electronic information, change the degree to which the aspect of the electronic information to be displayed is changed from the aspect before the acquisition information is added, in accordance with a position on the display at which the environmental information is generated.

14. The information processing apparatus according to claim 13, wherein the processor is configured to change the degree of change in accordance with a locus of the environmental information starting from an initial position to an end position on the display at which the environmental information is generated, as positions on the display at which the environmental information is generated.

15. The information processing apparatus according to claim 4, wherein the processor is configured to change the degree to which the aspect of the electronic information to be displayed is changed from the aspect before the acquisition information is added, in accordance with at least one of acquisition times of the use state of the electronic information and the environmental information by the acquisition unit.

16. The information processing apparatus according to claim 4, wherein the processor is configured to, in a case where the result of the acquisition includes a plurality of results, display the electronic information while providing priority to an aspect corresponding to a result whose predetermined priority level is high.

17. The information processing apparatus according to claim 1,
wherein the electronic information is an electronic book, and
wherein the processor is configured to
acquire presence or absence of advertising as the environmental information regarding the electronic book, and
in a case where there is the advertising, display the electronic book to which advertising information that matches the advertising has been added.

18. The information processing apparatus according to claim 1, wherein the processor is configured to, in a case where an aspect of the electronic information to be displayed is changed in accordance with at least one of the use state of the electronic information and the environmental information, when a predetermined condition is satisfied, return the aspect of the electronic information to be displayed to an aspect before the change is made.

19. The information processing apparatus according to claim 18, wherein a change of the aspect of the electronic information includes a reversible change in which return to the aspect before the change is made is possible in a case where the predetermined condition is satisfied and an irreversible change in which return to the aspect before the change is made is not possible even in a case where the predetermined condition is satisfied.

20. A non-transitory computer readable medium storing a program causing a computer to execute a process for information processing, the process comprising:
when executing software that is capable of displaying electronic information including at least one of a document and an image so that the electronic information is displayed, displaying the electronic information in an aspect that matches at least one of a use state of the electronic information and environmental information indicating environment around a place where the electronic information is displayed.
